(19) United States
(12) Patent Application Publication
(10) Pub. No.: US 2025/0261594 A1
(43) Pub. Date: Aug. 21, 2025

(54) APPARATUS AND METHODS FOR NARROW BANDWIDTH CONTROL OF METABOLIC PROCESSES

(71) Applicant: SYMBIOTIC SYSTEMS, INC., San Diego, CA (US)

(72) Inventors: Paul R. Bhola, San Diego, CA (US); Kenneth M. Happel, San Diego, CA (US)

(21) Appl. No.: 19/056,489

(22) Filed: Feb. 18, 2025

Related U.S. Application Data
(60) Provisional application No. 63/554,948, filed on Feb. 16, 2024.

(51) Int. Cl. A01G 7/04

(52) U.S. Cl. CPC A01G 7/045

(57) ABSTRACT

Lighting systems and methods for growing a plant can include providing a plant that has a known light control pattern for photosensory photoreceptors. Lights having wavelength characteristics that match the light control pattern for photosensory photoreceptors of the plant can be provided and controlled. A controller or user can change at least one of an intensity, a duration, and a periodicity of the lights to achieve a desired metabolic response in the plant. An exemplary method can include preventing light outside of the light control pattern, with an intensity that is above a lower bound required for the photoreceptors of the plant to be controlled, from making contact with the plant. A light cob can be configured with a predetermined light pattern used to cause a desired metabolic response in the plant when only (or substantially only) light emitted with the predetermined light pattern is incident upon the plant. A controller and memory including a plurality of recipes of narrowband light ranges can be provided to cause various desired metabolic responses in the plant when the controller actuates the light sources/light cob.

The present application claims priority under 35 U.S.C. 119 to provisional patent application 63/554,948 filed on Feb. 16, 2024, the entire contents of which is incorporated herein by reference.

### BACKGROUND

The disclosed subject matter relates to lighting, lighting systems, and methods for using light to affect one or both of photosynthesis and metabolic processes in plants, which can include but is not limited to vegetative or flowering plants, nuts, seaweeds, algae, bacteria, and fungi, as well as any organism that grows as a result of contact with light.

In one embodiment, the disclosed subject matter relates to the use of narrow-band Photosensory Active Radiation (PSAR)-from less than 200 nm to more than 2000 nm-light sources to illuminate growing plants in Controlled Environment Agriculture (CEA) environments.

### SUMMARY

Some embodiments of the disclosed subject matter are directed to various aspects that can be combined or interchanged.

### Aspects of the Disclosed Subject Matter

According to a first aspect 1, a method for growing a plant, can include: providing a plant that has a known light control pattern for photosensory photoreceptors; providing lights having wavelength characteristics that match the light control pattern for photosensory photoreceptors of the plant where such control pattern is selected to be an optimum cause of desired control behavior; changing at least one of an intensity, a duration, and a periodicity of the lights to achieve a desired metabolic response in the plant; preventing light outside of the light control pattern, with an intensity that is above a lower bound required for the photoreceptors of the plant to be controlled, from making contact with the plant until the desired metabolic response to the light control pattern has been obtained. According to aspect 2, providing lights includes providing at least one first light source that has a center frequency and bandwidth consistent with inclusion in the control pattern, and a second light source that has a center frequency and bandwidth consistent with inclusion in the control pattern, the second light source having a center frequency different from the center frequency of the first light source. According to aspect 3, the first light source is a narrowband light emitting diode having a wavelength range of 10 nanometers or less, and the second light source is a narrowband light emitting diode having a wavelength range of 10 nanometers or less. However, it does not have to be 10 nm if control pattern target wavelengths are spaced far enough apart. According to aspect 4, the lower bound is zero such that only light matching the control pattern is provided to the plant, and such that a continuous illuminating spectrum is not provided to the plant. According to aspect 5, preventing light includes placing the plant and lights into a confined space in which ambient light is prevented or restricted from entry into the confined space. According to aspect 6, changing at least one of an intensity, a duration, and a periodicity of the lights causes a signal pathway to exist such that the lights influence a primary or secondary metabolic process in the plant. According to aspect 7, changing at least one of an intensity, a duration, and a periodicity of the lights directly or indirectly causes a desired gene expression in the plant. According to aspect 8, the lights include a plurality of narrowband light sources that each have a bandwidth such that the intensities of the light from any combination of overlapping narrowband light sources added together, within their regions of spectral overlap, have a combined intensity that is below the lower bound, the lower bound defined by an intensity required for the photoreceptors of the plant to change the desired metabolic response of the plant to be controlled or cause an undesired response or initiate an undesired process or change any other process not directly part of the desired metabolic response, and the method further includes; operating the narrowband light sources in a first combination of frequency and intensity to invoke a desired signaling pathway in the plant but not in a second combination that invokes undesired signal pathways. According to aspect 9, the plurality of narrowband light sources each have a bandwidth of 10 nanometers or less. According to aspect 10, operating the narrowband light sources in the first combination of frequency and intensity invoke a circadian clock in the plant to cause the plant to flower. According to aspect 11, preventing light outside of the light control pattern from making contact with the plant includes preventing light with an intensity that is above the lower bound from making contact with the plant, the lower bound being an intensity required for the photoreceptors of the plant to change the desired metabolic response or initiate an undesired process or change any other process not directly part of the desired metabolic response. According to aspect 12, the method of aspect 1 can further comprise: providing at least one spectral imaging sensor connected to a controller, the at least one spectral imaging sensor configured to provide feedback information to the controller to confirm whether the desired metabolic response is occurring. According to aspect 13, providing a plant includes providing a plant that has a known light control pattern for photosensory photoreceptors and stimulates photosynthesis; and providing lights includes providing lights having wavelength characteristics that match the light control pattern for both photosynthesis and photosensory photoreceptors of the plant. According to aspect 14, the method of aspect 1-13 can further comprise: providing a controller that includes a memory in which a plurality of light pattern recipes are stored, each of the recipes corresponding to a different desired metabolic response for the plant; and operating the lights in accordance with one of the plurality of light pattern recipes such a that a plurality of discrete narrowband wavelength lights are incident upon the plant. According to aspect 15, the method of aspects 11-4, can further comprise: providing a controller that includes a memory in which a plurality of images or image representations of plants responding to light pattern recipes, are stored, each of the images or representations corresponding to a different desired process of the plant, growth status of the plant, pathology of the plant or other plant condition requiring response.

According to aspect 1A, a method for growing a plant, can include: providing a plurality of narrowband light emitting devices that each, during operation, emits light in a specific wavelength range that corresponds to a specific wavelength range that causes a predetermined process in the plant, each specific wavelength range having a range of 20 nanometers or less; placing the plurality of narrowband light emitting devices into a space; preventing ambient light from entering into the space; operating the plurality of narrowband light emitting devices to cause only light within each specific wavelength range to be incident upon the plant. According to aspect 2A, the specific wavelength range is a wavelength range of 15 nanometers or less. According to aspect 3A, the specific wavelength range is a wavelength range of 10 nanometers or less. According to aspect 4A, the plurality of narrowband light emitting devices includes a first narrowband light emitting device having a first wavelength range, a second narrowband light emitting device having a second wavelength range different from the first wavelength range, and third narrowband light emitting device having a third wavelength range different from the first wavelength range and the second wavelength range, and each wavelength range is 10 nanometers or less. According to aspect 5A, the plant is a tomato and the first, second and third wavelength ranges are selected from the group consisting of: 365+/−5 nm; 384+/−5 nm; 415+/−5 nm; 435+/−5 nm; 455+/−5 nm; 472+/−5 nm; 525+/−5 nm; 590+/−5 nm; 622+/−5 nm; 640+/−5 nm; 650+/−5 nm; 667+/−5 nm; and, 730+/−5 nm. According to aspect 6A, the plurality of narrowband light emitting devices includes light emitting diodes that each emit light within a 10 nanometer bandwidth. According to aspect 7A, the plurality of narrowband light emitting devices each, during operation, emits light in a specific wavelength range that in combination creates a first wavelength pattern that causes a predetermined process in the plant, each specific wavelength range having a bandwidth range such that intensities of the light from any combination of overlapping narrowband light sources added together, within their regions of spectral overlap, have a combined intensity that is below a lower bound required for photoreceptors of the plant to change a desired metabolic response of the plant to be controlled or cause an undesired response or initiate an undesired process or change any other process not directly part of the predetermined process; preventing ambient light includes preventing ambient light from entering into the space in an intensity greater than the intensity of the lower bound required for the photoreceptors of the plant to change the desired metabolic response of the plant to be controlled or cause an undesired response or initiate an undesired process or change any other process not directly part of the predetermined process; operating the plurality of narrowband light emitting devices includes operating the plurality of narrowband light emitting devices to cause only light within each specific wavelength range to be incident upon the plant in intensities above the lower bound required for the photoreceptors of the plant to change the desired metabolic response of the plant to be controlled. According to aspect 8A, the plurality of narrowband light emitting devices includes a first narrowband light emitting device or devices having a first wavelength pattern, a second narrowband light emitting device or devices having a second wavelength pattern different from the first wavelength pattern, and a third narrowband light emitting device or devices having a third wavelength pattern different from the first wavelength pattern and second wavelength pattern such that intensities of the light from any combination of overlapping narrowband light sources within a wavelength pattern added together, within regions of spectral overlap, have a combined intensity that is below a lower bound required for photoreceptors of the plant to change a desired metabolic response of the plant to be controlled or cause an undesired response or initiate an undesired process or change any other process not directly part of the predetermined process; and preventing ambient light includes preventing light from entering into the space in an intensity greater than the intensity of the lower bound required for the photoreceptors of the plant to change the desired metabolic response of the plant to be controlled or cause an undesired response or initiate an undesired process or change any other process not directly part of the predetermined process. According to aspect 9A, operating includes operating the plurality of narrowband light emitting devices in combination or in time series.

According to aspect 20. a lighting system for use on a plant, can include: a plurality of narrowband light emitting devices that each, during operation, emits light in a specific wavelength range, creating a first pattern of light composed of light at each of the specific wavelength ranges associated with a desired process of the plant, and such that intensities of light from any combination of overlapping narrowband light added together from light outside the specific wavelength ranges, within their regions of spectral overlap, have a combined intensity that is below a lower bound required for photoreceptors of the plant to change a desired metabolic response of the plant or cause an undesired response or initiate an undesired process or change any other process not directly part of the desired process; a housing connected to the plurality of narrowband light emitting devices; a controller connected to the plurality of narrowband light emitting devices and configured to, cause the first pattern of light to be emitted from the plurality of narrowband light emitting devices to initiate the desired process in the plant upon which the first pattern of light is incident, wherein the first pattern of light includes a plurality of lights each centered on a particular wavelength and having a narrowband wavelength range such that intensities of the light from any combination of overlapping narrowband light sources added together, within their regions of spectral overlap, have a combined intensity that is below the lower bound required for the photoreceptors of the plant to change the desired metabolic response of the plant or cause an undesired response or initiate an undesired process or change any other process not directly part of the desired process; and at least one spectral imaging sensor connected to the controller and configured to provide feedback information to the controller to confirm whether the desired process is occurring. According to aspect 21, the specific wavelength range is 20 nanometers or less and can be 10 nanometers or less. According to aspect 22, the at least one spectral imaging sensor connected to the controller is configured to provide feedback information to the controller to confirm whether an undesired response or an unrelated but undesired process is occurring. According to aspect 24. the controller is further configured to interpret a condition of the plant using the feedback information from the at least one spectral image sensor, and cause a second pattern of light to be emitted from the plurality of narrowband light emitting devices to initiate at least one of the desired process and a different process, in the plant, wherein the second pattern of light includes a plurality of lights each centered on a particular wavelength and having a narrowband wavelength range such that intensities of the light from any combination of overlapping narrowband light sources added together, within their regions of spectral overlap, have a combined intensity that is below the lower bound required for the photoreceptors of the plant to change the desired metabolic response of the plant or cause an undesired response or initiate an undesired process or change any other process not directly part of the different process, and the second pattern of light is different from the first pattern of light. According to aspect 25, the lower bound is an intensity at which photoreceptors of the plant fail to change a desired metabolic response of the plant. According to aspect 26, the at least one spectral imaging sensor connected to the controller and one visual spectrum imaging sensor are aligned so that pixels from each sensor can be spatially correlated and configured to provide feedback information to the controller to confirm whether the desired process is occurring or if an undesired process response is occurring. According to aspect 27, the controller includes a memory in which a plurality of light pattern recipes are stored, each of the recipes corresponding to a different desired process of the plant. According to aspect 28. the controller includes a memory in which a plurality of images or image representations of plants responding to light pattern recipes, or their absence or other undesired conditions, are stored, each of the images or representations corresponding to a different desired process of the plant, growth status of the plant, pathology of the plant or other plant condition requiring response. According to aspect 29a, the controller is further configured to interpret a condition of the plant using the feedback information from the at least one spectral image sensor, and output a warning notice to a user if a condition of the plant is not consistent with the desired process. According to aspect 29b, the controller is further configured to interpret a condition of the plant using the feedback information from the at least one spectral image sensor, and output a warning notice to a user if a condition of the plant is not consistent with the desired process, or is consistent with at least one plant pathology of the plant or other plant condition requiring response.

According to aspect 31, a method for using light to initiate a desired process in a plant, can include: providing a first narrowband light emitting device that, during operation, emits light in a first wavelength range that is 10 nanometers in width or less; providing a second narrowband light emitting device that, during operation, emits light in a second wavelength range that is 10 nanometers in width or less, the second wavelength range being different from and outside of the range of the first wavelength range; operating the first narrowband light emitting device and second narrowband light emitting device to cause light within the first wavelength range and second wavelength range to be incident upon the plant; and preventing light from light outside the first wavelength range and the second wavelength range from having an intensity that is above a lower bound required to cause an undesired response or to initiate an undesired process or to change any other process not directly part of the desired process in the plant. According to aspect 32, the desired process in the plant is flowering. According to aspect 33, the method of aspects 31 or 32 can further include: causing light from a first wavelength pattern that includes the first wavelength range, the second wavelength range, and a third wavelength range different from and outside of the range of the first wavelength range and second wavelength range, to be incident upon the plant. According to aspect 34, the method of aspects 31, 32 or 33 can further include: providing at least one spectral imaging sensor connected to a controller; and providing feedback information from the at least one spectral imaging sensor to the controller to confirm whether an undesired response or an undesired process is occurring. According to aspect 35, the method of aspects 31-34 can further include: providing at least one spectral imaging sensor connected to a controller; and providing feedback information from the at least one spectral imaging sensor to the controller to confirm whether the desired process is occurring. According to aspect 36, the method of aspects 31-35 can further include: providing a controller connected to at least the first narrowband light emitting device and the second narrowband light emitting device, the controller configured to, cause a first pattern of light to be emitted from the narrowband light emitting devices to initiate the desired process in the plant upon which the first pattern of light is incident, wherein the first pattern of light includes a plurality of lights each centered on a particular wavelength and having a narrowband wavelength range such that intensities of the light from any combination of overlapping narrowband light sources added together, within their regions of spectral overlap, have a combined intensity that is below a lower bound required for photoreceptors of the plant to change the desired process of the plant or cause an undesired response or initiate an undesired process or change any other process not directly part of the desired process; and providing at least one spectral imaging sensor connected to the controller and configured to provide feedback information to the controller to confirm whether the desired process is occurring. According to aspect 37, the method of aspects 31-36 can further be characterized in that the controller includes a memory in which a plurality of light pattern recipes are stored, each of the recipes corresponding to a different desired process of the plant.

According to aspect 40. a method for using light to initiate activity in a plant, can include: providing at least one light emitting device; selecting a plant that exhibits a first desired response when light having a first wavelength range is incident upon the plant, and that exhibits a second desired response when light having a second wavelength range is incident upon the plant, causing light from the first wavelength range to be incident upon the plant; causing light from the second wavelength range, different from the first wavelength range, to be incident upon the plant; preventing light that is outside of the first wavelength range and second wavelength range from being incident upon the plant, wherein the first wavelength range is a narrowband range of 10 nanometers or less, and the second wavelength range is a narrowband range of 10 nanometers or less. According to aspect 41, the at least one light emitting device includes a plurality of light emitting diodes, and each of the plurality of light emitting diodes is configured to emit light within a narrowband wavelength of 10 nanometers or less, and at least one of the plurality of light emitting diodes is configured to emit light within the first wavelength range, and at least a second of the plurality of light emitting diodes is configured to emit light within the second wavelength range. According to aspect 42, preventing includes providing the at least one light emitting device in a space, and preventing ambient light from entering the space. According to aspect 43, at least one of the plurality of light emitting diodes is configured to emit light within a third wavelength range, the third wavelength range is a narrowband range of 10 nanometers or less, and preventing includes preventing light that is outside of the first wavelength range, second wavelength range, and third wavelength range from being incident upon the plant. According to aspect 44, preventing includes preventing light with an intensity that is above a lower bound required for photoreceptors of the plant to cause a desired metabolic response from the plant, from making contact with the plant. According to aspect 45, the method of aspects 41-44, can further include: causing a first light pattern to be incident on the plant, the first light pattern associated with a first recipe for causing a particular metabolic response from the plant. According to aspect 46, the method of aspects 41-45, can further include: providing a controller connected to the light emitting diodes, the controller configured to cause a first pattern of light to be emitted from the light emitting diodes to initiate a particular metabolic response in the plant upon which the first pattern of light is incident, wherein the first pattern of light includes a plurality of lights each centered on a particular wavelength and having a narrowband wavelength range such that intensities of the light from any combination of overlapping narrowband light sources added together, within their regions of spectral overlap, have a combined intensity that is below a lower bound required for photoreceptors of the plant to change the particular metabolic response of the plant or cause an undesired response or initiate an undesired process or change any other process not directly part of the particular metabolic response. According to aspect 47, the method of aspects 41-46, can further include: providing at least one spectral imaging sensor connected to the controller and configured to provide feedback information to the controller to confirm whether the particular metabolic response is occurring. According to aspect 48, the method of aspects 41-47, can further include: the controller including a memory in which a plurality of light pattern recipes are stored, each of the recipes corresponding to a different particular metabolic response for the plant.

According to aspect 50, a method for controlling a plant, can include: providing a plurality of narrowband light emitting devices that each, during operation, emits light in a specific wavelength range that corresponds to a specific wavelength range that causes a predetermined process in the plant, each specific wavelength range having a range such that intensities of the light from any combination of overlapping narrowband light sources added together, within their regions of spectral overlap, have a combined intensity that is below a lower bound required for the photoreceptors of the plant to change a desired metabolic response of the plant to be controlled or cause an undesired response or initiate an undesired process or change any other process not directly part of the predetermined process; placing the plurality of narrowband light emitting devices into a space; preventing ambient light from entering into the space; an operating the plurality of narrowband light emitting devices to cause a first pattern of light to be incident upon the plant, wherein the first pattern of light includes a plurality of lights each centered on a particular wavelength and having a narrowband wavelength range of 10 nanometers. According to aspect 51, the method of aspect 50, can further include: operating the plurality of narrowband light emitting devices to cause a second pattern of light to be incident upon the plant, wherein the second pattern of light includes a plurality of lights each centered on a particular wavelength and having a narrowband wavelength range of 10 nanometers, the first pattern of light being different from the second pattern of light. According to aspect 52, the method of aspects 50-51, can further include: preventing ambient light from entering into the space in intensities above the lower bound required for the photoreceptors of the plant to change the desired metabolic response or initiate an undesired process or change any other process not directly part of the desired process, from making contact with the plant. According to aspect 53, the method of aspects 50-52, can further include: causing a first light pattern to be incident on the plant, the first light pattern associated with a first recipe for causing a particular metabolic response from the plant. According to aspect 54, the method of aspects 50-53, can further include: providing a controller connected to the light emitting devices, the controller configured to cause a first pattern of light to be emitted from the light emitting devices to initiate the predetermined process in the plant upon which the first pattern of light is incident, wherein the first pattern of light includes a plurality of lights each centered on a particular wavelength and having a narrowband wavelength range such that intensities of the light from any combination of overlapping narrowband light sources added together, within their regions of spectral overlap, have a combined intensity that is below a lower bound required for photoreceptors of the plant to change the predetermined process from occurring in the plant or cause an undesired response or initiate an undesired process or change any other process not directly part of the predetermined process. According to aspect 55, the method of aspects 50-54, can further include: providing at least one spectral imaging sensor connected to the controller and configured to provide feedback information to the controller to confirm whether the predetermined process is occurring. According to aspect 56, the method of aspects 50-55, can further include: the controller includes a memory in which a plurality of light pattern recipes are stored, each of the recipes corresponding to a different predetermined process for the plant. According to aspect 60, a method for initiating at least one predetermined activity in a plant, can include: providing a plurality of narrowband light sources configured to emit light of different colors and a common intensity; providing a plant; and actuating the plurality of narrowband light sources such that a specific pattern of narrowband lights is incident upon the plant, wherein the specific pattern of narrowband lights correlates to a first predetermined activity in the plant. According to aspect 61, the method of aspect 60, can further include: wherein each of the narrowband light sources is configured to emit light within a 20 nm bandwidth, or within a 10 nm bandwidth. According to aspect 62, the method of aspects 60-61, can further include: wherein the specific pattern of narrowband lights includes at least three narrowband lights having different colors each centered at a particular wavelength, having a bandwidth of 20 nm or less, and not overlapping with the bandwidth of each other. According to aspect 63, the method of aspects 60-62, can further include: actuating the plurality of narrowband light sources such that a second specific pattern of narrowband lights is incident upon the plant, wherein the second specific pattern of narrowband lights correlates to a second predetermined activity in the plant, wherein the second specific pattern of narrowband lights is different from the first specific pattern of narrowband lights, and the first predetermined activity in the plant is different from the second predetermined activity in the plant. According to aspect 64, the method of aspects 60-63, can further include: referencing a plurality of recipes stored in a memory, the recipes correlating a plurality of predetermined light patterns with a plurality of predetermined plant activities; actuating the plurality of narrowband light sources in accordance with a recipe selected from the plurality of recipes. According to aspect 65, the method of aspects 60-64, can further include: wherein the common intensity is common to narrowband lights sources having a same color. According to aspect 66, the method of aspects 60-65, can further include: wherein narrowband light sources having a first color have a first intensity, and narrowband light sources having a second color have a second intensity, where the first color is different from the second color, and the first intensity is different from the second intensity. According to aspect 67, the method of aspects 60-66, can further include: wherein narrowband light sources having a first color have a first intensity, and narrowband light sources having a second color have a second intensity, where the first color is different from the second color, and the first intensity is the same as the second intensity. According to aspect 68, the method of aspects 60-67, can further include: wherein the specific pattern of light includes at least three lights having different colors each centered at a particular wavelength, having a bandwidth of 10 nm or less, and not overlapping with the bandwidth of each other.

According to aspect 70, a system for initiating at least one predetermined activity in a plant, can include: a plurality of narrowband light sources configured to emit light of different colors; a controller configured to actuate the plurality of narrowband light sources; and at least one sensor in communication with the controller, the sensor configured to obtain data related to an environment of the plant including hyperspectral imagery which includes images composed of single spectral images along with humidity and pH, nutrient, temp; wherein the controller is configured to actuate the plurality of narrowband light sources such that a specific pattern of narrowband lights is incident upon the plant based on the data received from the sensor. According to aspect 71, the method of aspect 70, can further include: wherein the controller is configured to actuate the specific pattern of narrowband lights in accordance with a light recipe stored in a memory associated with the controller, such that specific pattern of narrowband lights initiates a first predetermined activity in the plant. According to aspect 72, the method of aspects 70-71, can further include: wherein each of the narrowband light sources is configured to emit light within a 10 nm bandwidth. According to aspect 73, the method of aspects 70-72, can further include: wherein each of the narrowband light sources is configured to emit light within a 20 nm bandwidth. According to aspect 74, the method of aspects 70-73, can further include: wherein the specific pattern of narrowband lights includes at least three narrowband lights having different colors each centered at a particular wavelength, having a bandwidth of 20 nm or less, and not overlapping with the bandwidth of each other. According to aspect 75, the method of aspects 70-74, can further include: wherein the controller is configured to actuate the plurality of narrowband light sources such that a second specific pattern of narrowband lights is incident upon the plant, wherein the second specific pattern of narrowband lights correlates to a second predetermined activity in the plant, wherein the second specific pattern of narrowband lights is different from the first specific pattern of narrowband lights, and the first predetermined activity in the plant is different from the second predetermined activity in the plant. According to aspect 76, the method of aspects 70-75, can further include: wherein the controller is configured to reference a plurality of recipes stored in a memory, the recipes correlating a plurality of predetermined light patterns with a plurality of predetermined plant activities, the controller further configured to actuate the plurality of narrowband light sources in accordance with a recipe selected from the plurality of recipes. According to aspect 77, the method of aspects 70-76, can further include: wherein the plurality of narrowband light sources have a common intensity. According to aspect 78, the method of aspects 70-77, can further include: wherein narrowband light sources having a first color have a first intensity, and narrowband light sources having a second color have a second intensity, where the first color is different from the second color, and the first intensity is different from the second intensity. According to aspect 79, the method of aspects 70-78, can further include: wherein narrowband light sources having a first color have a first intensity, and narrowband light sources having a second color have a second intensity, where the first color is different from the second color, and the first intensity is the same as the second intensity. According to aspect 79B, the method of aspects 70-79, can further include: wherein the specific pattern of light includes at least three lights having different colors each centered at a particular wavelength, having a bandwidth of 10 nm or less, and not overlapping with the bandwidth of each other.

According to aspect 90, the methods, systems and lighting devices defined above in aspects 1-79B can be configured with any feature of any other aspect(s), and can be configured to omit any feature of any of the other aspect(s) if/when combined, and still fall within the scope of the disclosed subject matter.

### BRIEF DESCRIPTION OF THE DRAWINGS

FIG. 1 is a graph of wavelength vs. absorbance showing peak absorbance for chlorophyll a and chlorophyll b.

FIG. 2 is a graph of wavelength vs. absorbance showing peak absorbance for chlorophyll a and chlorophyll b and chemical characteristics of each.

FIG. 3 is a graph of wavelength vs. absorbance showing peak absorbance for various photoreceptor groups.

FIG. 4 is a graph of wavelength vs. absorbance showing Phototropin Adsorption.

FIG. 5 is a series of graphs of wavelength vs. absorbance showing CRY1 and Cry2 Absorption Spectra.

FIG. 6 is a graph of wavelength vs. absorbance showing types of Metabolic Pathways.

FIG. 7 is a schematic depiction of a Network of Hormone Effects on Hormone Metabolism

FIG. 8 is a schematic depiction of the Network of Hormone Effects on Hormone Metabolism of FIG. 7.

FIG. 9 depicts the Central Dogma of Microbiology and Gene Expression.

FIG. 10 shows Phytochrome Correlation.

FIG. 11 shows Cryptochrome and Phototropin Correlation.

FIG. 12 is a table showing various narrow band LEDs and their effects.

FIG. 13 is a table showing LED Frequency Targets.

FIG. 14 is a table that lists the LED manufacturing semiconductor materials used by the frequency group they emit in current diode availability.

FIG. 15 is a top perspective view of a light cob for use in the presently disclosed subject matter.

FIG. 16 is a bottom perspective view of the light cob for use in the presently disclosed subject matter.

FIG. 17 shows an example of an M5V4A Revision 8 LED Cob.

FIG. 18 shows graphs of wavelength vs. intensity depicting the Spectral Evolution of the M5V4A Light Cob of FIGS. 16 and 17.

FIG. 19 shows two spectra as measured by an Uprtek spectrophometer.

FIG. 20 shows spectral changes as a function of time.

FIG. 21 are graphs that show Grow Mass and Efficiency per Watt.

FIG. 22 is a graph that efficiency of the use of the presently disclosed method and apparatus vs conventional art devices and methods.

FIG. 23 is a graph that efficiency of the use of the presently disclosed method and apparatus vs conventional art devices and methods.

FIG. 24 is a graph of wavelength vs. absorbance showing peak absorbance for Pr Phytochrome and Pfr.

FIG. 25 shows Phytochrome Cross-section Values.

FIG. 26 shows the GLAB-2 Case.

FIG. 27 Phytochrome Response to Narrow Band Trigger.

FIG. 28 depicts schematically an exemplary light A900-A1 having a red lighting unit with three LED cobs M5A, M5b and M5C.

FIG. 29 is a table that shows LED and Driver Specifications Used.

FIGS. 30A and 30B are graphs that depict A1 100% v. 80% Spectra, respectively.

FIGS. 31A and 31B are graphs that depict B1 100% v 80% Spectra, respectively.

FIG. 32 is a graph of wavelength vs. intensity for an HPS device.

FIGS. 33-35 show various lighting units and their measured PPFD intensity 36 inches below the lighting unit as a function of location.

FIG. 36 is a graph of wavelength vs. PPFD showing the role of intensity in frequency combinations.

FIG. 37 is a graph of wavelength vs. PPFD vs. relative intensity.

FIG. 38 is a graph of wavelength vs. time vs. relative intensity.

FIG. 39 is a graph of wavelength vs. intensity.

FIG. 40 is a table of narrowband light triggers.

FIG. 41 is a graph of wavelength vs. relative intensity showing phytochrome absorption.

FIG. 42 is a graph of wavelength vs. relative intensity showing phytochrome action.

FIG. 43 is a graph of wavelength vs. relative intensity showing a lower limit value.

FIG. 44 is a graph of wavelength vs. relative absorbance showing 10 nm illuminators.

FIG. 45 is a graph of wavelength vs. relative absorbance showing a Narrow Enough value.

FIG. 46 is a close up of a portion of FIG. 45.

FIG. 47 is a graph of wavelength vs. relative intensity with lower limit shown.

FIG. 48 is a graph of wavelength vs. relative intensity for Pr phytochrome switch.

FIG. 49 is a graph of wavelength vs. relative intensity for Pfr phytochrome switch.

FIG. 50 is a chart showing metabolic signals for narrowband light.

FIG. 51 is a graph showing wavelength for various carotenoids.

FIG. 52 is a graph of wavelength vs. intensity.

FIG. 53 is a graph showing wavelength vs. reflectance.

FIG. 54 is a graph showing wavelength vs. relative intensity for Pr-Pfr absorption.

FIG. 55 is a graph showing wavelength vs. relative intensity for Pr Action Spectrum.

FIG. 56 is a graph showing wavelength vs. relative intensity of Pr-Pfr Spectrum.

### DETAILED DESCRIPTION

Light sources that produce between 50% and 90% of their light in a frequency band 10 nanometers wide and centered on the frequencies stimulating major pigments involved in photosynthesis can cause results that are unique when compared to the state-of-the-art plant growing lights available.

The stimulation of photosynthesis energy transfer can occur using specific discontinuous narrow bandwidth light sources instead of illuminating plants with continuous broadband imitations of solar light spectrums (or, lunar/moon light spectrums). Narrow-band illumination for photosynthesis can use lower energy consumption levels and therefore can achieve lower costs of usage than broadband sunlight-imitating illuminators.

A large number of plant reactions can be observed that are inexplicable as effects caused by the process of photosynthesis. The field of science, photomorphogenesis, has been transformed and several others created by the modeling of genomes, metabolic pathways. The role of light as a regulator of gene expression can provide a basis for explaining the inexplicable observed effects of using specific discontinuous narrow bandwidth light sources.

The technical leading edge in CEA plant growth is based on replacing sunlight or supplementing it in optimized sunlight CEA environments, providing automated and mechanized growth care such as special feeding, temperature control and humidity maintenance systems that imitate, even when optimized, growing in natural environments.

In each case, the lighting component is a form of continuous spectrum light over the frequency range known as Photosynthetically Active Radiation (PSAR). PSAR covers a spectral range from less than 200 to more than 2000 nanometers. PSAR is offered to the plant using LED grow-lights. The current CEA industry state-of-the-art results are consistent with growth in optimum natural growth environments where the sun provides PSAR continuous spectrum light over the same ranges.

In one embodiment, we do not offer plants continuous PSAR spectrum radiation. Instead, we offer the plants approximately fifteen to 20 nanometers total bandwidth of essentially single frequency lights out of the 180 to 2200 possible single frequency lights that make up every continuous PSAR spectrum. This embodiment shows that when compared to plants grown under state-of-the-art grow lights:
plant size, vigor, leaf density, and speed of growth were significantly different, and in some cases significantly improved compared to PSAR spectrum illuminators,
the number of flowers and fruit produced in lower leaf structures were significantly more plentiful than those grown under PSAR illuminators,
the nutrient value of some of the fruit the fruit produced was significantly altered compared to PSAR and in many cases improved, and
specific plant hormones called terpenes in Cannabis were produced in amounts up to five times more than considered possible for the species involved.

In other embodiments, we can offer plants more than 20 single frequencies, and provide a larger range of total wavelength in total nanometers of essentially single frequency lights, including lights tuned for at least 28 known signals that can receive either single frequency or a larger frequency wavelength.

To understand the light-pattern plant interactions one can observe many combinations of LED light frequencies and intensities using a wide variety of narrow-band PSAR light sources with leaf produce, vegetable, and fruit producing plants. Unlike any other systems, this embodiment does not offer the plants some version of the whole PSAR spectrum illumination in any of these combinations.

In one example, a system can include nine to fifteen specific narrow-band frequencies with either no PSAR continuum light between them or dramatically reduced PSAR light intensities that are fundamentally different than those based upon imitation sunlight illumination amplifying the chlorophyll dominated photosynthesis process to define plant responses. Responses have now been defined and organized by the chemical processes triggered within the test plants. Other examples can include use of three to one thousand specific narrow-band frequencies, or more (or less). In addition, the narrowband frequencies could range from 200-3,000 nm each being as narrow as 1 nm, if appropriate.

The response can also be measured by sequencing plant genomes and identifying how plant growth responses are initiated and controlling plant genetic responses to stimuli during growth. These genetic responses are formed by chains of chemical reactions triggered by combinations of reactions forming if-this-then-that sequences called metabolic pathways.

Based on research into plant metabolic pathways, metabolic processes, and plant lifecycle growth chemistry, photochemically driven metabolic signaling systems in plants that control the exact types of unusual plant behavior can be observed. While some of these signaling processes are connected to and affect photosynthesis, their signaling actions are regulatory in nature and affect every type of plant growth response and are not part of the photosynthetic transfer of energy from photons to electrons.

Further, these regulatory signals evoke differences that are uniquely different from and impossible to dynamically control with plant lighting systems that are not based upon narrow-band illumination or that do not offer specific trigger signal inducing frequencies as supplemental lights and are NOT based upon the replacement and optimization of photosynthesis with imitation sunlight.

The result can be considered to be a new CEA technology that involves: the stimulation and triggering of metabolic responses in plants by irradiating them with static or dynamically changing narrow-band photomorphogenetic trigger patterns during the plant's growth lifecycle while constraining PSAR spectrum radiation to narrow-band illuminators or reducing the bandwidth areas of photosynthetic radiation to lower light intensity in the photomorphogenesis frequencies to the point where narrow-band or supplemental lighting allows metabolic signal control. These frequencies may include sources for the support of photosynthesis or may be supplemental to some other provision of metabolic activity.

The disclosed subject matter involves the stimulation and triggering of metabolic responses in plants by irradiating them with static or dynamically changing narrow-band photomorphogenetic PSAR light patterns during the plant's growth lifecycle while constraining photosynthetic radiation to narrow-band illuminators or reducing the bandwidth areas of PSAR spectrum radiation to lower light intensities in the photomorphogenesis frequencies to the point where narrow-band or supplemental lighting allows metabolic signal control.

The disclosed subject matter includes providing a specific light frequency and intensity of that specific frequency relative to the presence and intensities of other specific frequencies to form combinatorial elements for the creation of light pattern instructions that trigger the activation of gene expressions, control plant growth behaviors, and regulate dynamic plant processes. This process can work when the grow-light produces either no light between narrow band frequencies or spectral intensities low enough that the plant sees the low intensity as equal to no trigger signal frequency intensity being present in its photoreceptors. Dynamically changing narrow-band patterns may include changes to the frequencies offered, the photon intensity (PPFD) of the frequencies, or both.

### Plant Metabolic Processes

Metabolism in plants is the collection of interrelated biochemical reactions that maintain plant life. A series of metabolic processes happen in different parts of the plants such as leaves, stems, and roots. These processes include photosynthesis, respiration, and nitrogen fixation. The metabolic processes in plants can include: Photosynthesis, Respiration, Protein synthesis, Solute transport, Nutrient assimilation, Nitrogen fixation.

A metabolic pathway within a metabolic process is a series of connected chemical reactions that feed one another. The pathway takes in one or more starting molecules and, through a series of intermediates, converts them into products.

Metabolic pathways and cycles are either catabolic (energy-releasing) or anabolic (energy-consuming). Catabolic reactions break down complex metabolites into simpler ones, whereas anabolic reactions build up (biosynthesize) new molecules.

The metabolic processes in plants are affected by both internal and external factors. A number of processes exist whereby plants sense these factors and signal responses.

The energy for plant metabolic processes comes from light in a frequency range known as Photosynthetically Active Radiation. Light interacts with plant metabolic processes through the photoelectric effect which photon energy is absorbed by a pigment and transferred to atoms, or molecules or electrons are energized and conducted to sites where that energy is harvested within a metabolic process.

### Photosensory Active Radiation (PSAR)

Sunlight as we see it is called the visible spectrum and its primary purpose is illumination. Plants use light differently and have a much greater frequency range of interaction.

Around 50% of the total radiation from sunlight falls under photosensory active radiation (PSAR) and can support the process of photomorphogenesis. It constitutes light of 200-2000 nm wavelength which is absorbed by chlorophyll and other plant pigments acting as photoreceptors.

### Photoelectric Effect

A photon can't become an electron, but it can transfer its energy to an electron. This process is called the photoelectric effect.

When a photon hits an absorbing material, it transfers its energy to an electron. In order to transfer photon energy into an electron, the photon must have enough energy to change the energy state of the electron causing the electron to change its role in the electronic structure of the atom. This amount of energy is called electron bandgap.

Essentially, when a photon strikes the surface of a material with an electron bandgap, it can transfer its energy to an electron in the material, causing it to be excited from the valence band (where electrons cause atoms to be bound together) to the conduction band (where electrons are free to roam from atom to atom). This results in the creation of a free electron, which can then be used for various purposes, such as electrical power generation, electronic device operation, or causing changes in molecular structures or bonding.

### Pigments

A pigment is any substance that absorbs light. The color of the pigment comes from the wavelengths of light reflected (in other words, those not absorbed).

### Pigment Color

Black pigments absorb all of the wavelengths that strike them. White pigments/lighter colors reflect all or almost all of the energy striking them.

### Absorption Pattern

Pigments have their own characteristic absorption spectra, the “Absorption Pattern” of a given pigment. The absorption spectra.

### Narrow Photosynthetic Absorption Patterns

The various pigments involved in photosynthesis have absorption patterns that reveal they are not wide band but have specific narrow band peaks. Light sources can be used to replace sunlight for photosynthesis by using narrow band light centered on the absorption peaks for chlorophylls and carotenoids.

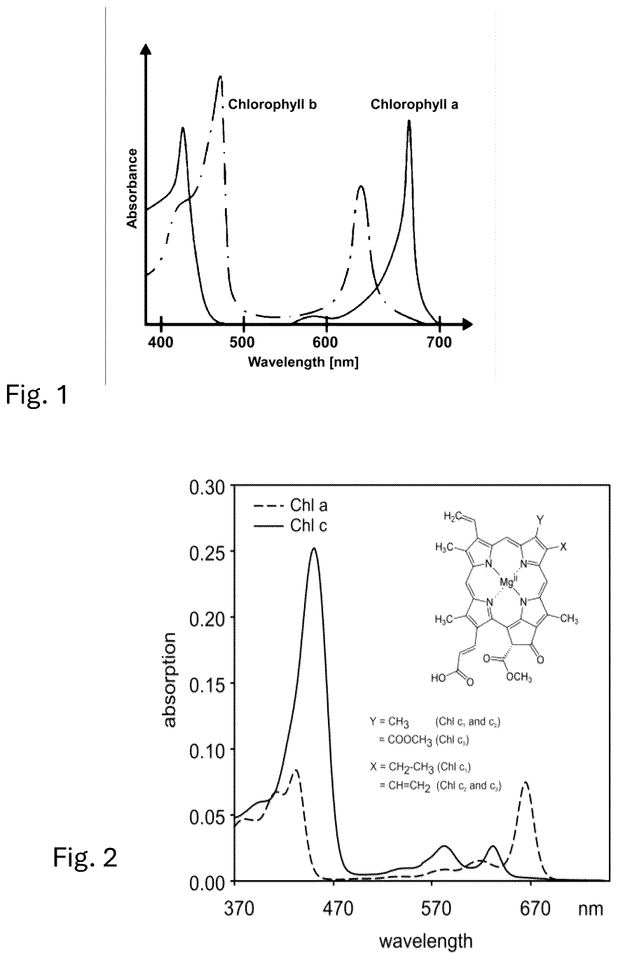

As shown in FIGS. 1 and 2, the core photosynthetic frequencies are 430, 453, 642, 662 nm. These match the maximum absorption peaks of the chlorophylls and carotenoids and prove to cause very high levels of photosynthetic response equal or superior to sunlight.

However, a new and unique process explanation can be that when using narrow band PSAR spectra for direct stimulation of photomorphogenetic processes or signaling occurs, metabolic changes occur dramatically altering plant behavior in CEA environments.

### Color and Absorption Patterns In Photoreceptive Compounds

Black pigments absorb all of the wavelengths that strike them. White pigments/lighter colors reflect all or almost all of the energy striking them. Pigments have their own characteristic absorption spectra, the “Absorption Pattern” of a given pigment.

### Action Spectrum

The action spectrum of photoreceptive compounds is the relative effectiveness of different wavelengths of light at generating energy transfer to electrons. If a pigment absorbs light energy, one of three things will occur.
Energy is dissipated as heat,
The energy may be emitted immediately as light of longer wavelength (a phenomenon known as fluorescence),
The energy may be made available to the plant's energy transport system as in photosynthesis.

Energy may trigger a photosensory response.

Each pigment has specific response to wavelengths that they absorb and no other. The photosynthetic response to absorption is to re-emit the photons or fluoresce. Photons change their frequency and therefore their specific energy content with each absorption and fluorescence until the photon has the right frequency/energy-level to be absorbed by a pigment in a reaction center in a membrane. Photosensory response causes a change in its associated base molecule, often a protein, that changes the reactive chemistry of the associate base molecule.

### The CEA Grow-Light Spectrum.

Plants do both photosensory response and photosynthesis if the right spectrum of artificial light is provided. LEDs, or light-emitting diodes, can mimic continuous spectrum artificial light to ensure proper plant development without burning them and have taken over the market because they can equal solar light intensities more economically than other sources. But these spectra do not have the ability to trigger specific single responses.

One example of dynamic control of plant metabolic systems by dynamic light control can include either turning lighting systems off or turning supplemental broad-spectrum lights on imitating diurnal patterns in daylight.

Some of the Photosensory Prototype Narrow-Bands in nm:
300; 330 (new); 350 (new); 420; 425 (main); 430 (main); 435 (main); 440; 445 (main); 453 (main); 460; 475 (main); 480 (main); 495; 524; 550; 576; 645; 650 (main); 660; 662-680 (main); 740; and, 850.

### Epigenetics

Epigenetics is the study of changes in organisms caused by modification of gene expression rather than alteration of the genetic code itself. The normal mRNA processes steps including transcription, processing, splicing, alternative splicing, transport, translation, storage and decay are massively reprogramed by light in the gene expression of plants.

One characterization of Epigenetics is the external and conditional process control of gene expression outside the primary metabolism processes that governs plant growth.

### Gene Expression Reprograming By Light

When activated by photons, photoreceptors are linked to signaling pathways that lead to changes in gene expression. There are at least thirteen photoreceptors that respond predominantly either to red and far-red light, or to blue and UV-A light.

Depending on the environment a young seedling encounters, the developmental program following seed germination could be skotomorphogenesis in the dark or photomorphogenesis in the light. Light signals are interpreted by a repertoire of photoreceptors followed by sophisticated gene expression networks, eventually resulting in developmental changes.

The expression and functions of photoreceptors and key signaling molecules are highly coordinated and regulated at multiple levels of the central dogma in molecular biology. Light activates gene expression through the actions of positive transcriptional regulators and the relaxation of chromatin by histone acetylation.

Light induces massive reprogramming of gene expression in plants. Small regulatory RNAs help attenuate (reduce) the expression of light-responsive genes. Alternative splicing, protein phosphorylation/dephosphorylation, the formation of diverse transcriptional complexes, and selective protein degradation all contribute to proteome diversity and change the functions of individual proteins.

Phosphorylation/dephosphorylation phosphorylation is a biochemical process in which a phosphate molecule is added to some organic compound, such as glucose (sugar) and adenosine diphosphate (ADP). In the latter example, the addition of phosphate group converts ADP to adenosine triphosphate (ATP), which is a very important compound that is used to provide the plant with energy to carry out metabolic processes in its living cells. Specific combinations of photoreceptor signals cause modified results. In other words, a specific photoreceptor color absorbed by a protein or pigment may cause different outcomes in the presence of other pigment and protein signals.

This allows for a very great complexity of instruction to be invoked by light patterns. It is also why actual control cannot be caused by continuous spectrum illumination sources. Control is caused by change in specific frequencies of the continuum. The continuous spectrum around the specific may actually be noise or detrimental to a specific gene expression trigger. The disclosed subject matter is about controlling these very combinations or plant process reprograming combinations by specifically and intentionally triggering them with specific narrow band frequencies.

Plants have evolved intricate light-regulated transcriptional networks that mediate these developmental changes.

Through genetic and molecular approaches, many key downstream regulators in the network have been identified. A large proportion of them are transcription factors, some of which have a role in mediating the response to a wide range of light signals and are therefore potential integration points for light-quality-specific signals.

Massive reprogramming of the plant mRNA transcriptome can be caused by light; for example, at least 20% of the genome in both Arabidopsis thaliana and rice shows light-regulated differential expression during seedling development. Many of the early light-responsive genes are transcription factors.

Organ-specific expression profiles are observed, indicating that different transcriptional networks are recruited in different organs and cell types.

The integration of light signals with intrinsic signals (such as those from the circadian clock) and other environmental signals (such as temperature) is evident through research on photoperiod response and seed germination. The photoperiod response also regulates other light-controlled processes.

So gene expression occurs through mRNA as modified by a combination of internal plant processes like the circadian clock and environmental signals captured in real time. That means that any gene expression can have hundreds and even thousands of metabolic meanings. The initiation of almost all processes internal or real-time in are caused by signals related to specific frequencies and intensities of light captured by photoreceptors.

### Photomorphogenesis

Photomorphogenesis is the change in form or function of an organism in response to changes in the light environment. In photomorphogenesis organisms perceive external light cues, including wavelengths (or colors) of light available and light intensity, and subsequently adjust cellular metabolism, organismal growth, and development to optimize survival in response to a dynamic light environment. In fact, the metabolic process signals initiated by photoreceptors impact plant gene expression.

### Photoreceptors and Photoresponse

Photoreceptors absorb a photon of a particular wavelength and utilize this energy, thus initiating a photoresponse. Plants possess two types of photoreceptors: photosynthetic pigments that harvest light energy for photosynthesis (harvesting photons is the energy transfer process discussed earlier), and photosensory receptors that mediate non-photosynthetic light responses.

Plants rely on spectral cues present in their surroundings, generated by their constantly changing light environment, to guide their growth and reproduction. The molecules used by plants to detect light cues are termed photoreceptors. Photoreceptors mediate the capture of information by plants from the light environment over a wide range of wavelengths.

A battery of sensory photoreceptors with spectral specificity provides plants with multiple environmental cues including light and temperature to cause photoresponses that direct increase fitness, yield, and biomass in agriculture. Non-photosynthetic sensory photoreceptors detect varying:

Wavelength frequency, Irradiance or quantity (Photosynthetic Photon Flux Density (PPFD) is the amount of light that reaches a plant canopy within the PSAR range. PPFD measures the number of photosynthetically active photons that fall on a given surface each second.), flux (obsolete-luminous flux is a measure of the brightness of a light source in terms of energy being emitted measured in lumens.

Direction, and Duration & Periodicity (Duration is the plant's ability to sense a light frequency's period of presence or duration through photoreceptors that accurately detect alterations in the spectral composition (UV-B to far-red) and are located throughout the plant. Photoperiodism is the ability of plants to use light to track time. Plants use photoreceptors to sense the wavelengths of sunlight available during the day (versus night) and throughout the seasons. Plants have evolved sensitive mechanisms to measure the length of the photoperiod, which is the length of the light period in the diurnal cycle of 24 h. Photoperiodism allows some plant species to flower—switch to reproductive mode—only at certain times of the year.)

Irradiance using PSAR is sometimes insufficient (not broad enough) because non-photosynthetically active photoreceptors sense a wider range of frequencies than those that are photosynthetically active (especially at germination).

Once again, irradiance is still currently defined in a widely agreed to and used terminology that supports the imitation sunlight illumination paradigm and is different than our methodology where light is being directly used to directly empower (photosynthesis) and control (photomorphogenesis) plant processes as distinct functions without sunlight or imitation of any kind being desired or necessary except as a cost reducer.

To explain why the narrow-band horticultural paradigm is so different, the main frequency of chlorophyll-a pigment is 662 nm. The control frequency for Pr phytochrome photoreceptor activation controlling a family of metabolic pathways and gene expressions for plant growth is 666 nm. Four nanometers difference.

Continuous band or anything other than our really narrow band definition can allow photosynthesis and impede growth at the same time. It is these types of narrowband initiated photoresponse combinations that combine to directly and deliberately reprogram plant growth processes in horticulture.

### Light Processing and the Photosensory Spectrum

Light processing, the post-harvest light processing of food, uses electro-magnetic radiation in the non-ionizing region of the spectrum between 170 and 1,100 nm (IR to UV includes ultraviolet (UV,50-400 nm), visible (VIS,400-700 nm) and infrared (IR, 700-1,100 nm) light with the intensity of the radiation expressed as irradiance or intensity flux (Wm-2). and the dose expressed as radiant exposure or fluence (kJm-2). Light processing has shown that “the intense photoreactivity of proteins as well as the large variability of the deriving structures suggests a wide potential of light radiation in modifying functionality of food proteins. The modulation of rheological, film, emulsifying, and foaming properties of proteins are examples of the possibilities provided by light processing to improve the technological performance of protein-rich ingredients. Similarly, the significant effects of light on activity of enzymes and reactivity of allergens reveal unexplored possibilities to use this physical process to steer protein biological properties.

Because many of these properties also impact the metabolic performance of living plants, the use of light at these light frequencies to influence photosensitive proteins and enzymes indicate that the photosensory frequency spectrum be broadened. Including VFIR indicators in germination the photosensory spectrum should be considered from 150 nm to 3000 nm.

### Photoreceptors

Light sensing in plants involves special molecules called photoreceptors, which are made up of a protein linked to a light-absorbing pigment called a chromophore. When the chromophore absorbs light, it causes a change in the shape of the protein, altering its activity and starting a signaling pathway. The signaling pathway results in a response to the light cue, such as a change in gene expression, growth, or hormone production. The absence of light based protein change is also a valid trigger when it sustains an interrelated state like a circadian clock process.

Photoreceptors absorb a photon of a particular wavelength and utilize this energy, thus initiating a photoresponse. Plants possess two types of photoreceptors: photosynthetic pigments that harvest light energy for photosynthesis, and photosensory receptors that mediate non-photosynthetic light responses. All the known photosensory photoreceptors (except UVR8) can consist of (or include) proteins bound to non-protein light-absorbing prosthetic groups (chromophores). Non-photosynthetic photoreceptor chromophores are chemically flavonoids, a flavin plus a pterin, carotenoids (zeaxanthin), a linear tetrapyrrole, chromoproteins, retinal, and hormones (auxin, ABA, gibberellin, ethylene, brassinosteroids, cytokinin, and jasmonic acid) among others.

The protein structures of the different photoreceptor chromophores vary and are involved in regulation of downstream signaling. Within the metabolic pathways, the states of the chromophore proteins act as switches determining which actions within the pathway are activated. Photoreceptors, including phytochromes, cryptochromes and phototropins, help plants regulate developmental processes over their lifetime by sensitizing them to incident light. They also initiate protective processes in response to harmful radiation.

### Chromophore States Cause

In phototropism a plant bends or grows directionally in response to light. Shoots usually move towards the light; roots usually move away from it.

In photoperiodism flowering and other developmental processes are regulated in response to the photoperiod, or day length.

Short-day plants flower when day length is below a certain threshold, while long-day plants flower when day length is above a certain threshold.

In many plants, photoperiodism is controlled by the overlap between the day length cue and the plant's internal circadian rhythms.

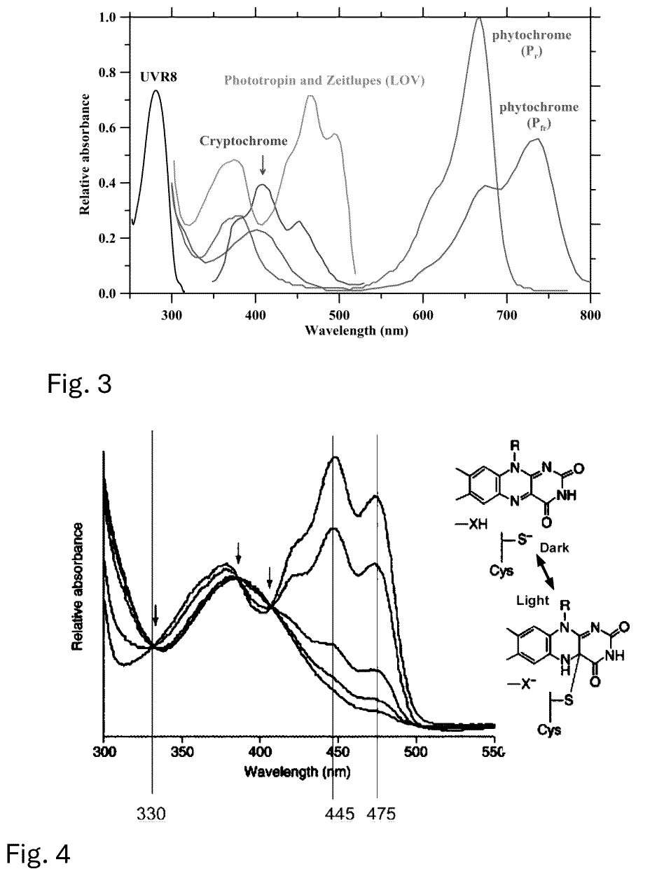

As shown in FIG. 3, there are five major groups of photoreceptors identified in plants including the red/far-red perceiving phytochromes, blue-light cryptochromes, and phototropins. In addition, a new class of blue-light photoreceptors has been identified called Zeitlupes.3 Further, there are photoreactive Hormone compounds that signal as well.

Among the metabolic processes the photoreceptor photoresponses affect include: regulation of de-etiolation and photoperiodic control of flowering, entrainment of the circadian clock, guard cell development and stomatal opening, root growth, plant height, fruit and ovule size, apical meristem activity (germination & causing branch & root tip growth), programmed cell death, the high-light stress response, osmotic stress response, responses to fungal, bacterial and viral pathogens, Responses to fungal, bacterial and viral symbiotes, leaf expansion, changes in hormonal levels, production of secondary metabolites, and release of volatile compounds.

### Phytochrome Receptors

Phytochromes are a type of photoreceptor that plants use to detect light. They are sensitive to light in the red and far-red region of the visible spectrum. Phytochromes are present in almost all eukaryotic plants and play a crucial role in regulating plant growth and development.

Among the things regulated: Seed germination; Chlorophyll synthesis; Seedling elongation; Leaf size, shape, number, and movement; and Initiation of flowering.

Phytochromes are proteins with an attached pigment molecule that allows them to detect light. When activated by red or near-infrared radiation, phytochromes play a role in initiating floral and developmental processes by initiating chemical response based upon the protein that is activated by the light reaction. Phytochromes act as a biological light switch. They monitor the level, intensity, duration, and color of environmental light. In response to different wavelengths of light, phytochromes convert between inactive and active forms. This conversion is used to synchronize plant development to the light environment.

### Phototropin Receptors

Phototropins are blue light receptors for key physiological responses: Phototropism, which causes stems to bend towards light; Light-induced stomatal opening, respiration, and heat release; Chloroplast movements in response to changes in light intensity; Positive phototropism of shoots towards light; Negative phototropism of roots away from light; Chloroplast accumulation, and avoidance increase/decrease photosynthetic capability; Leaf expansion-process that plants use to increase/decrease leaf surface based upon light levels, water availability, etc. and capture energy; and Seedling elongation.

These responses aid photosynthesis in efficiently obtaining light, decreasing photodamage and acquiring CO2. Phototropins are thought to optimize photosynthesis by helping plants capture light energy efficiently, reduce photodamage, and acquire CO2.

FIG. 4 shows Phototropin Adsorption.

phot1, phot2

The action spectrum of plant phototropins is in the UV-A and blue light range (360-500 nm). The wavelengths 405, 458, 473, and 488 nm all proved to be effective. A light dose of 6.2 μJ over a 10 μm spot at 458 nm induced a cellular response with a single exposure. This was the lowest power setting (0.1% of total power on the mW scale of our Fluoview 1000 confocal microscope at very fast scan rate (10 us/pixel). Cryptochrome Receptors

Cryptochrome and phytochrome are essential for the adjustment of growth strategies to the light environment. Cryptochrome is a blue/UV-A (B/UV-A) photoreceptor, while phytochrome mediates various responses to red/far-red (R/FR) light. Cryptochrome responds primarily to UVA/blue light (peak near 450 nm) and only weakly above 500 nm, consistent with oxidized flavin as a primary photosensor.

Green light hurts cryptochrome response. For example, the reduced cryptochrome chromophore absorbs broadly at all wavelengths of green light (500-600 nm) [19, 20], and wavelengths including 531, 540, 567, 582, and 591 nm have been shown to specifically decrease cryptochrome 2 response to blue light [18].

Cryptochromes regulate: changes to the transcriptome; inhibition of hypocotyl elongation; stimulation of cotyledon expansion; promotion of floral initiation; entrainment of the circadian clock; stimulation of stomata opening, fostering pathogen resistance; suppressing leaf senescence; inhibiting germination of dormant grain; regulating stomatal development; shade avoidance; and light-dependent stress response.

### CRY1, CRY2

CRY1 Cryptochrome 1 is a blue light receptor (440 nm) that regulates plant growth and development. CRY1 is the primary inhibitor of hypocotyl elongation. It also regulates anthocyanin accumulation and cotyledon expansion. CRY1 is stably expressed in the light and regulates plant growth and development at higher light intensity.

CRY1 and CRY2 have partially redundant and overlapping functions. CRY2 inhibits hypocotyl elongation under low blue light intensity. CRY2 also promotes flowering under long-day conditions. Cry2 overexpression in transgenic plants increases blue-light-stimulated cotyledon expansion, which results in many broad leaves and no flowers rather than a few primary leaves with a flower.

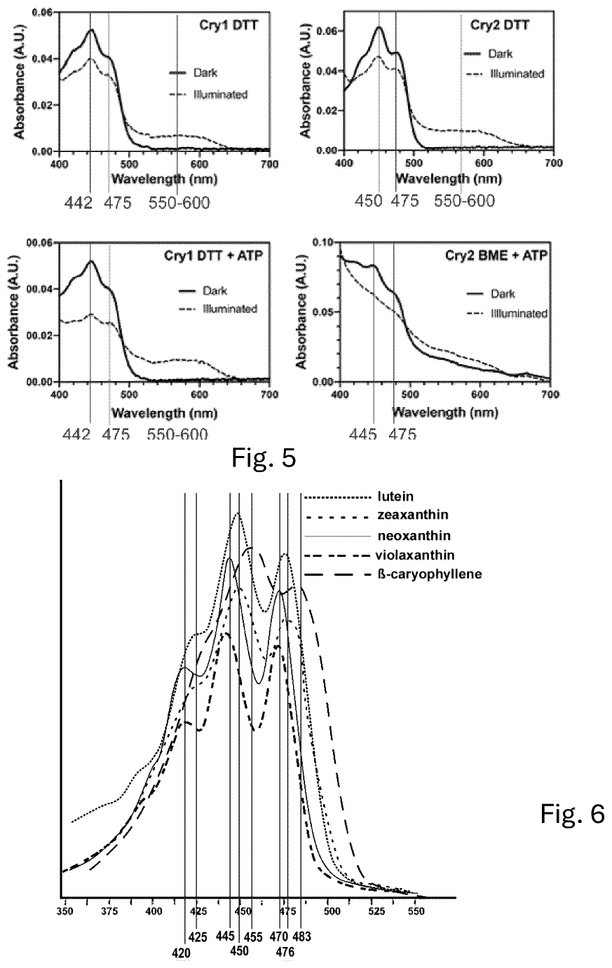

FIG. 5 shows CRY1 and Cry2 Absorption Spectra CRY3

CRY3 can also act as a dual function photoreceptor in mitochondria and chloroplasts.

### Phytochrome/Cryptochrome Interaction

Crys and Phys act under different colors of the light spectrum to regulate related developmental processes via two independent but shared signaling pathways. These two common signaling pathways and direct Cry-Phy interactions provide clues to understand the molecular mechanisms underlying the co-action of Crys and Phys.

However, Cry and Phy differentially regulate light responses via the preferential selection of signaling pathways that lead to the regulation of Phytochrome Interaction Factors (PIF) activity.

PIFs are central regulators of photomorphogenic development that act to promote stem growth, and this activity is reversed upon interaction with Phy in response to light.

Cryptochromes function like phytochromes but are stimulated by blue-light and connected to the phytochromes by the PIFs.

### Zeitlupe Receptors

ZEITLUPE (ZTL) is a light-sensitive protein that helps plants keep their circadian clocks in sync with the cycle of night and day. ZTL is a blue light photoreceptor and clock component. It helps plants predict when dawn will occur so they can harness sunlight to fuel their growth.

### FKF1

(450 nm)

### LKP2

(470 nm)

### UV-A

(320-500 nm)

### UVR8

(280-320 nm)

### Plant Hormones

By convention hormones are said to be substances whose site of synthesis and site of action are different; the two events are separated by space and time.

### Hormones

FIG. 6 shows types of Metabolic Pathways.

### Zeaxanthin

Zeaxanthin is a carotenoid hormone and absorbs light in the blue light range of the visible spectrum. The maximum light absorbance of zeaxanthin is between 445 and 472 nm in dichloromethane and 451 nm in ethanol.

### Brassinolides (BR Hormones)

BRs are a class of growth hormones. Naturally occurring brassinolide steroids are found in nearly all plants, algae, ferns, gymnosperms, and angiosperms. It is found in highest concentrations in the pollen, immature seeds, flowers, and roots of plants.

Scientists have been researching brassinolide steroids for years as a natural fertilizer, mainly for agricultural plants. Brassinolide steroids, also known as brassinosteroids, are naturally occurring plant hormones that regulate a plant's growth, development, and immunity. The hormone is naturally produced, as needed, to help plants grow, create pollen, set flowers, fruits and seeds, and resist diseases or pests. It also promotes the growth of lateral buds, produces leaves with a deeper and darker green color, and increases the number of flowers and fruit produced.

The most potent BR is brassinolide. Brassinolide is a plant growth regulator that helps regulate plant growth and development. It is a biologically active brassinosteroid that is naturally produced by plants. Brassinolide helps plants resist stress conditions such as disease, drought, salt, and cold.

Brassinolide can be understood using rapeseed plants [3] (Brassica napus). The brassinolide hormone can be isolated and extracted. It can then be introduced to other plants by different methods to study the effect the extra hormones may have on the test plants' growth and resilience. The results are larger, healthier plants which showed more resistance to pests, diseases, extreme heat, drought, extreme cold, nutrient deficiencies, and salt. These test plants also produced higher yields of fruit or seeds, and flower bud drop, and fruit drop were decreased.

The stimulation range is 2,632 nm to 10,000 nm (Intermediate infrared: 1,400 to 5,000 nm and Far, long wavelength, infrared: 5,000 to 1,000,000 nm. Light and brassinosteroid (BR) are external stimuli and internal cue respectively, that both play critical roles in a wide range of developmental and physiological processes. Seedlings grown in the light exhibit photomorphogenesis, while BR promotes seedling etiolation. Light and BR oppositely control the development switch from photomorphogenesis in the dark to photomorphogenesis in the light. Simply said it switches the plant to above ground living when the seedling breaks out of the soil.

### Photoresponses and Metabolic Pathways

Metabolic pathways are a series of connected, enzyme-catalyzed, chemical reactions that feed one another and takes one or more starting molecules, through a series of intermediates, and converts them into products. Metabolic Pathways and Hormone Interaction

Investigation on the effects of hormones on plants has revealed that the hormones elicit a wide array of responses in different types of tissues in the same plant body. The responses to the hormonal treatments may depend upon the kind of tissue and the physiological state of the tissue. For example, in a developing stem segment, in response to GA3, the internodes elongate considerably but the same hormone in maize grains elicit the synthesis of Alfa amylase enzymes is aleurone cells.

Thus the specific response to a particular hormone depends upon the inbuilt potentiality of the said tissues; this behavior is because of its previous developmental programs.

The Auxin which induces the growth in one part of the plant body, fails to bring about the same effect in the other part, but it may have different effects like apical dominance, new root formation or parthenocarpy, etc., at different site.

While GA is known to bring about the gene activation in aleurone cells leading to the synthesis of alfa amylase, the same hormone acts on rosette shaped Hyoscyamus plant and induces bolting and flowering. But in pea plants, it overcomes genetic dwarfism. The above observations suggest that each and every phytohormone elicit more than one response in the same plant body but at different sites. Furthermore as all hormones are synthesized at different sites within the same plant body, the said hormones interact with each other, and control the growth and development.

### Phytohormones, Hormonal Interplay and Plants' Responses:

Use of phytohormones in tissue cultures, have revealed that though a single hormone has a specific effect, two or more hormones together at different concentrations, elicit different responses in tissue.

In the presence of two different hormones, the effects may be promotive, synergistic or antagonistic where one may modify the activity of the other. Such reactions are referred to as hormonal interplay.

Plant hormones play a major role in plant growth and development. They affect similar processes but, paradoxically, their signaling pathways act nonredundantly. Hormone signals are integrated at the gene-network level rather than by cross-talk during signal transduction.

In contrast to hormone-hormone integration, data suggests that light and plant hormone pathways share common signaling components, which allows photoreceptors to influence the growth program. The present disclosure proposes a role for the plant hormone auxin as an integrator of the activities of multiple plant hormones to control plant growth in response to the environment.

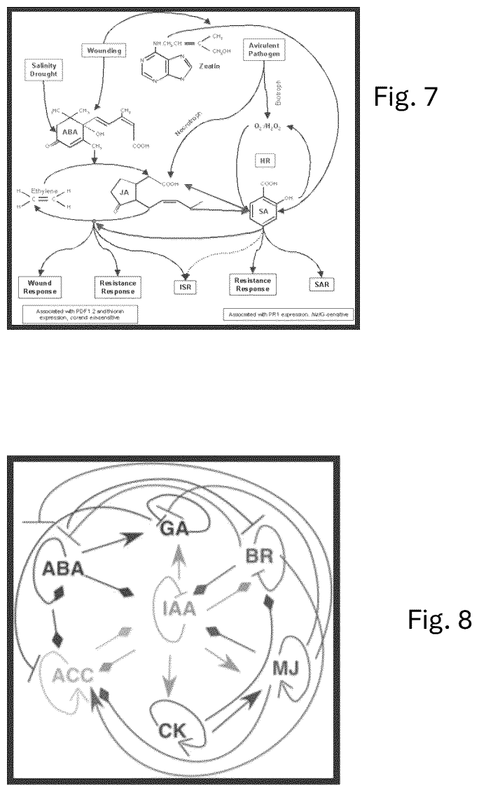

FIG. 7 and FIG. 8 depict the: Network of Hormone Effects on Hormone

### Metabolism

Genes assigned to hormone biosynthetic pathways by GO annotation were identified within lists of hormone-responsive genes. Lines with arrowheads represent up regulation of hormone biosynthetic genes or down regulation of genes involved in hormone inactivation. Blocked arrows represent down regulation of genes involved in hormone biosynthesis or up regulation of genes involved in inactivation of a hormone. Diamond arrowheads indicate changes in gene expression with ambiguous outcomes (i.e., genes affected include those linked to both increased and decreased hormone levels).

‘Lines with arrowheads, up regulation of hormone biosynthetic genes or down regulation of genes involved in hormone inactivation; blocked arrows, down regulation of genes involved in hormone biosynthesis or upregulation of genes involved in their function. Plant hormones play a major role in plant growth and development. They affect similar processes but, paradoxically, their signaling pathways act nonredundantly.

Hormone signals are integrated at the gene-network level rather than by crosstalk during signal transduction. In contrast to hormone-hormone integration, recent data suggest that light and plant hormone pathways share common signaling components, which allows photoreceptors to influence the growth program. The disclosed subject matter proposes a role for the plant hormone auxin as an integrator of the activities of multiple plant hormones to control plant growth in response to the environment.

### The Central Dogma of Microbiology and Gene Expression

The central dogma of molecular biology is a theory stating that genetic information flows only in one direction, from DNA, to RNA, to protein, or RNA directly to protein. The triggering of the release of central dogma information in plants is caused by signal from internal processes and photoreceptors.

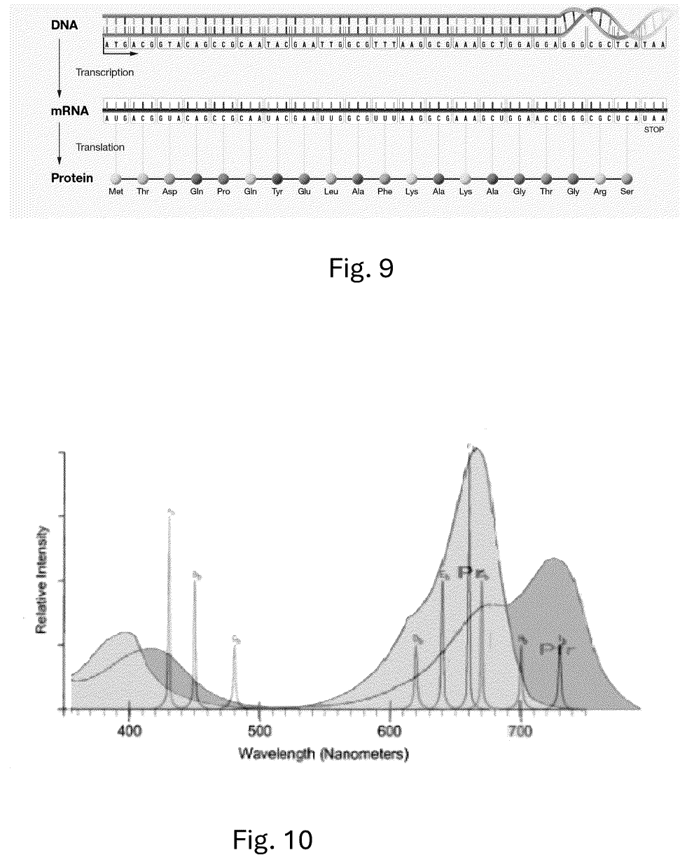

FIG. 9 depicts the Central Dogma of Microbiology and Gene Expression.

Specific photoreceptor signals become modified when the signals occur in combination with other signals. As a result, regulation of gene expression can occur at different levels in the central dogma of molecular biology. Environmental light signals set off a series of molecular actions at almost every step of the dogma for gene expression regulation.

### Pathway Triggers to Gene Expression

It is recognized that cell metabolism is tightly connected to other cellular processes such as regulation of gene expression. Metabolic pathways not only provide the precursor molecules necessary for gene expression, but they also provide ATP, the primary fuel driving gene expression. However, metabolic conditions are highly variable since nutrient uptake is not a uniform process. Thus, cells must continually calibrate gene expression to their changing metabolite and energy budgets.

Genes in the same metabolic pathway have closely associated functions and are more likely to be co-regulated and expressed in similar ways. Plant metabolic pathways are generally not known to occur in clusters, although there are about 20 reported cases of specialized metabolic pathways that occur as gene clusters. Photosynthesis and Gene Expression

Carbon metabolite-mediated repression of genes involved in photosynthesis. Carbon metabolite concentrations may affect the expression of genes encoding photosynthetic components in two different ways. The depletion of sugars leads to activation of gene expression and to an increase in photosynthetic capacity. Circadian Clock and Gene Expression

Plants are able to utilize their internal circadian clock to synchronize physiology and development according to daily and yearly environmental changes and season cycles. The circadian clock comprises a substantial number of gene activations and inhibitions in multiple feedback regulations. The CIRCADIAN CLOCK ASSOCIATED 1 (CCA1) gene encodes a MYB-related transcription factor involved in the phytochrome induction of a light-harvesting chlorophyll a/b-protein (Lhcb) gene. Expression of the CCA1 gene is transiently induced by phytochrome photoreceptors and oscillates with a circadian rhythm. LHY and CCA1 are partially redundant genes required to maintain circadian rhythms.

### Diurnal Sensing and Gene Expression

The diurnal cascade of gene activation initiates at dawn with a pick of CCA1 circadian clock gene transcripts. Throughout the day, PRR9, PRR7, and PRR5 transcripts spike up early in the morning, mid-day, and afternoon, respectively. Notice each of the circadian clock genes corresponds to a specific day period of time.

### Seasonal Sensing and Gene Expression

The decreasing number of hours of light, which starts right after the beginning of autumn, also works as an indicator to enter dormancy, preventing the detrimental effects that winter conditions might have on plant cells. Plants also react to variations of low and high light intensities (e.g., acclimation), which involves a set of environmental adjustments such as leaf morphology variations, chloroplast structure, and/or modification of the composition of the photosynthetic electron transport chain, consequently affecting photosynthesis. Each of these changes represent changes in gene expression caused by triggers in metabolic pathways.

### Economic Significance of Light Controlled Terpene Gene Expression

Despite the therapeutic and industrial potential of specialized plant metabolites (SM, also called secondary metabolites), their total chemical synthesis is often prohibitively expensive or even impossible due to their structural complexity. As a consequence, most of the SM are still extracted from their plant sources.

The plant sources are often difficult to cultivate, resulting in the overharvesting of these species from the wild, as exemplified by firmoss (Huperzia serra), the pacific yew (Taxus brevifolia), and golden root (Rhodiola rosea).

Furthermore, many valuable SM can be present at low concentrations in plants, precluding the production of these beneficial molecules in a cost-efficient manner. Consequently, large efforts are underway to understand the SM biosynthetic pathways, as these pathways can be engineered into more suitable microbial or plant hosts and further modified to produce novel, more potent compounds.

The disclosed subject matter shows this exact effect produced in Cannabis with a five times increase in Beta-Caryophyllene terpene production. The global caryophyllene market growth can be attributed to:

Increasing use of caryophyllene as flavor and fragrance ingredient in the food and beverage cosmetics, and personal care industries is driving the growth of the market.

Caryophyllene is known for its medicinal properties and is being used as a functional ingredient in various food and beverage products including supplements, functional drinks and snacks.

It has shown special pharmacological properties including: strong anti inflammatory properties, anti-cancer pharmaceutical capability, anti anxiety, among others.

The restraint to market growth is finding high quality volume. The demonstrated capability of 500% higher yield has indicated disruptive market ROI on the large volume feed stocks the market is currently capable of consuming but cannot supply.

### The Metabolic Crop Management

Lighting for Controlled Environment Agriculture can include three types of sunlight replacement or sunlight optimization:
Supplementing sunlight in greenhouses and specialized outdoor growing conditions,
Replacing sunlight in CEA environments, and
Optimizing photosynthetic processes by sunlight spectrum enhancement.

In each case, the light offered to the plants is a continuous spectrum of frequencies providing illumination within the paradigm of illumination by sunlight. The devices used are all based upon the combined use of medium to broad-spectrum light emitting diode (LED) devices.

When choosing LED lights for a retrofit, one consideration is the type of spectrum you need. Typically, there are two options which are broad spectrum (white light) or red/blue spectrum. For many indoor grows, where they rely on artificial lights as their only source of light to grow plants, full or broad-spectrum “white light” LEDs are the best option. This is because broad-spectrum LEDs offer plants a more complete spectrum-similar to natural sunlight-that can be used for all stages of growth. Broad spectrum LEDs are also better for workers because white light is easier to work under than blue/red light and makes plant assessment much easier.

Red and blue LEDs, where the light appears pink or purple, are usually recommended for supplementary lighting in greenhouses, where plants are already receiving full spectrum sunlight from the outdoors. Since photosynthesis peaks in the blue and red spectrums, photons are more easily converted into photosynthetic energy at these wavelengths and therefore increase the overall energy efficiency of the lights.

Narrow band illuminators may not be available from either the CEA or LED industry. In fact, unless the LED drivers used dramatically lower the power to the LED devices, narrow band behavior is difficult to be created in current LED devices.

The use of narrow-band lighting systems with lighting spectra like the one below (actual nine frequency light used) can provide benefits. Each of these LED lights has between 50% and 92% of its total luminous energy between plus or minus five nanometers of the center frequency (+/−5 nm). The growth results can be surprising. The initially desired result to prove photosynthesis could be supported with essentially two narrow band sources was confirmed.

The focus on narrowband photosynthesis was a reflection of the industry-wide economic retraction caused by a world-wide increase in electricity prices. The industry response has been a virtual doubling in the photonic output of CEA LEDs. But doubling the output means that narrow band spectra become even harder to achieve.

However, the following results were not explicable or reproducible by photosynthetic replacement of sunlight alone:
Early Girl tomatoes produced different fruit properties than the same cultivar grown in control group competitive lighting,
Early Girl tomatoes produced the same number of flowers and fruit in the vegetive body as in the leaf crown,
Basil plants produced significantly greater dry weights of leaves used as spice,
Novel GMO rice strains that refused to flower for seed production after extensive tests by Salk, flowered immediately,
A standard cannabis cultivar produced the highest levels of β-caryophyllene ever tested and multiples of the amounts produced in control groups, and
When one of the narrow band lights was missing, Early Girl tomatoes grew roots at the leaf crown buds above ground.

The above results do not correlate with photosynthesis. The results do correlate with various photomorphogenesis research results into the regulation of metabolic processes by photoreceptor signaling.
Extraordinary fruit properties
Same number of flowers & fruit in the vegetive body as in the leaf crown; greater dry weights of Basil leaves; rice that refused to flower, flowered immediately; Massive increase in specific terpene (B-caryophyllene) production, and Faulty gene expression (grew roots at the leaf crown buds). Phytochrome; Phytochrome, Cryptochrome; Phototropism, Phytochrome; Phytochrome, Brassinolide; Phytochrome, Brassinolide; Phototropism, Phytochrome.

When lighting units have no light frequencies other than its nine specific colors, those nine colors can be considered to be triggering photoreceptors other than the pigments associated with photosynthesis. The answer is the photoreceptor colors of photomorphogenesis. When one superimposes the phytochrome adsorption spectrum on top of the narrow band spectra used in the presently disclosed subject matter, the correlation between the phytochrome excitation frequencies and the narrow band frequencies used becomes apparent.

The specific wavelength triggers for actuating tomato plant growth (each wavelength having +−5 nanometer variability) are: 365; 384; 415; 435; 455; 472; 525; 590; 622; 640; 650; 667; and, 730. Thus, a 10 nm (narrowband) light centered at each of these frequencies (having +−5 variability centered at each of the frequencies) can be caused to be incident upon the tomato plant, while all light outside this recipe can be actively prevented, removed and/or kept below a threshold for photosensory actuation, in accordance with principles of the presently disclosed subject matter.

FIG. 10 shows Phytochrome Correlation.

The same occurs with cryptochrome and phytotropins.

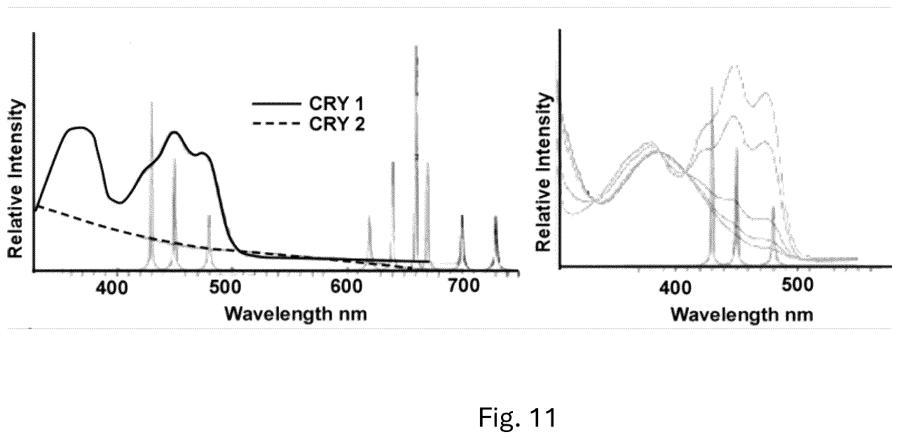

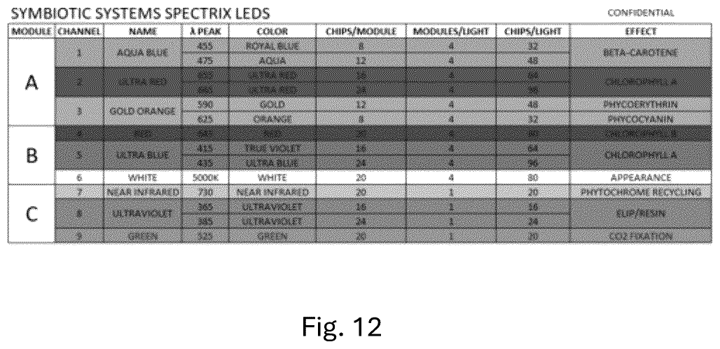

FIG. 11 shows Cryptochrome and Phototropin Correlation.

The lights can be configured to use multiple color and intensity patterns changing in both frequency and intensity during each day, as well as during growth season cycles to specially stimulate growth.

These changes are caused because of the stimulation of specific photomorphogenic signal patterns within the plants by changes in the light quality during the day. Plants are diurnal because they grow during the day and night by different processes, all of which are responding to photomorphogenic signals or the effect of those signals.

### Plant Fluorescence

Plants not only receive light but they irradiate light in a process called fluorescence. Blue fluorescence BF is characterized by a main maximum in the 450 nm region and in most cases by a second maximum/shoulder in the 530 nm region. The latter has been termed green fluorescence GF. The red chlorophyll fluorescence RF, in turn, exhibits two maxima in the 690 and 730 nm region.

In general, the intensity of BF, GF and RF emission is significantly higher in the lower than the upper leaf side. The ratio of BF to RF emission (F450/F690) seems to vary from plant species to plant species. BF and GF emission spectra appear to be a mixed signal composed of the fluorescence emission of several substances of the plant vacuole and cell wall, which may primarily arise in the epidermis.

Leaves with removed epidermis and chlorophyll-free leaves, however, still exhibit a BF and GF emission (Candidates for the blue fluorescence emission (lambda max near 450 nm) are phenolic substances such as chlorogenic acid, caffeic acid, coumarins (aesculetin, scopoletin), stilbenes (t-stilbene, rhaponticin), the spectra of which are shown.

GF emission (lambda max near 530 nm) seems to be caused by substances like the alkaloid berberine and quercetin. Riboflavine, NADPH and phyllohydroquinone K1 seem to contribute little to the BF and GF emission as compared to the other plant compounds).39 Diurnal and Growth Cycle Control By Light

The following is a discussion about photomorphogenesis and the general metabolic control of plants. The disclosed subject matter includes optimizing light and intensity patterns into time sequences that the plant can best use.

Typically, the spectrum of PSAR provided to a plant should be in accordance with the spectrum of irradiance which the plant absorbs . . . . Since some plants can, to some degree, adopt to the PSAR radiation that they receive, growing in a manner to use more of what spectrum and intensity of irradiance is available, it is logical to supply the plant with PSAR that matches its preferred absorption. In other words, supply an optimum spectral continuum following a PSAR absorption spectrum. However, this approach of supplying absorption spectrum light can be changed or improved upon because:
1. although most plants can tolerate all wavelengths, the plant poorly uses some or most wavelengths of PSAR, and does not need many of these wavelengths at all,
2. although the plant can and does, under the sun, tolerate continuous spectrum illumination including all those selected PSAR wavelengths it prefers, the plant may actually be hindered in its growth responses by continuous spectrum illumination, and
3. although plants can tolerate crude “synthetic daylight” (synthetic PSAR), many plants much prefer PSAR that, in some manner, replicates each of the (a) timing and (b) colors of the diurnal lighting pattern changes normal to the earthly locations (in latitude, local ground truth, altitude, prevailing weather patterns, etc, etc.) in which the plant is normally grown.

The presently disclosed subject matter strongly suggests that an earth plant has an internal cycle related to an earth day. The meaning, and cause, of this is unknown, but a green plant may be upon some sort of internal diurnal “schedule” to move materials around inside the plant, e.g., water and nutrients from the roots to the leaves, and nutrients to build cell mass to the ripening fruits.

This observation is of practical, as well as philosophical, importance. It will not be desirable to use electric energy to generate PSAR of wavelengths or intensities that, when applied to the plant at certain portions of the day, the plant does not appreciably want, nor appreciably use. Instead, it is much more efficient to give the plant the PSAR that it then wants and can then use.

The internal schedule that is referred to “a green plant may be upon some sort of internal diurnal “schedule” to move materials around inside the plant” has been shown to be completely correct. The key missing point is that the “internal schedule” is run and adapted minute to minute by photomorphogenesis signals within the plant.

Plants use circadian clocks to predict when dawn will occur so they can prepare to use sunlight for growth. Plants are sessile organisms, meaning they are fixed in one place and cannot escape when environmental conditions become unfavorable. Circadian rhythms allow plants to cope with adverse surroundings and synchronize themselves with predictable changes, such as the change from day to night.

The circadian plant clock works by the plant's ability to sense the presence of various “clock” proteins. The amount of clock protein plus the presence of various light signals causes the plant to know it is day. In the absence of light signals, it knows it is night and as the clock proteins degrade and become fewer, the plant can sense how late it is and how close the dawn is. The early morning is signaled by specific light frequency patterns that coupled with the low clock protein levels means it is dawn.

Light intensity, duration, direction, and wavelength are informative to plants. The biochemical circuits that connect specific light wavelengths to expression of specific genes and the metabolic networks they govern have been well defined. However, little emphasis has been placed on how discrete wavelengths of light, alone or in combination, may be applied to manipulate postharvest qualities of high-value horticultural crops.

### LED Frequencies

There are at least 16 narrow band light frequencies linked to metabolic processes and photosynthesis that can be used in the lighting unit designs. The center frequencies (nm) are listed below and the photomorphogenic pathways they belong to are in the Metabolic Targets Listed as follows: 365; 385; 415; 435; 455; 475; 525; 590; 625; 645; 655; and 665. (Center Frequencies (all in nm.))

FIG. 11 depicts a Metabolic Targets List.

The white light in the list is for use during grow-light maintenance and where a required specific frequency was missing and not yet identified.

Depending on the target behavior tested for, an entire library of LED frequency correlated growth results exists. Thus, the disclosed subject matter includes a method for triggering plant metabolic pathways into specific environmental responses.

The number of known and research defined metabolic trigger frequencies is at least twenty-eight (28). These are listed in “The Photomorphogenesis Triggers”.

### The Research

Fourteen sets of research trials results were reviewed:

### The Exemplary Light Evolution

The lights made in accordance with the disclosed subject matter can include wooden or metal lighting frames. In one example, metal framed lights can be named A, B, and C and each represent a different light pattern selection.

The lights can be formed in nearly a hundred different cob designs. Diurnal and life cycle patterns, along with photomorphogenesis and metabolic control is a goal of these lighting systems and methods, as these listings copied for the LED design sheets indicate.

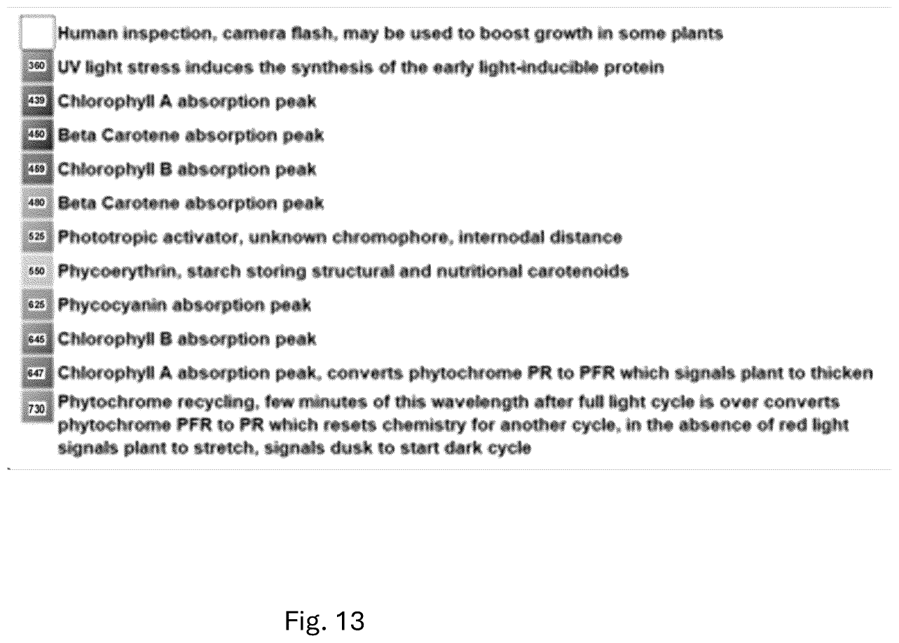

FIG. 13 depicts LED Frequency Targets.

The LED lights can be selected as linked to the frequencies of various known photosynthetic processes in the plant. The LED lights can also be selected based on metabolic process triggers. The diurnal responses to daytime changes in sunlight illumination can have a relationship to photomorphogenesis. The figure above shows design notes of one group of LEDs chosen and the relationships to plant chemistry for them.

### Available LED Frequency Technology

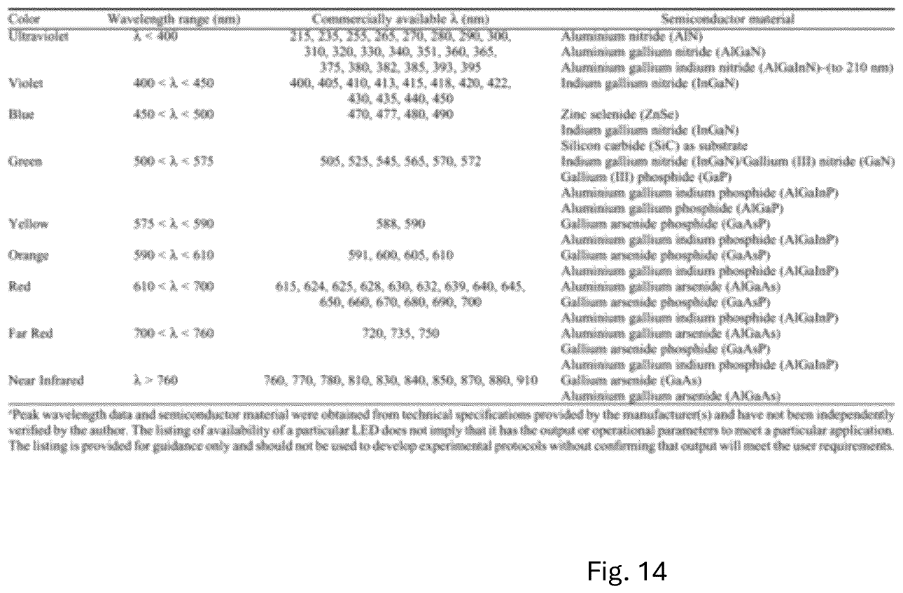

LED manufacturing technology has now been developed that covers most of the photosensory spectrum. FIG. 14 is a Table that lists the LED manufacturing semiconductor materials used by the frequency group they emit in current diode availability.

### The Light Cobs.

Exemplary lighting units of the disclosed subject matter went through a large number of evolutionary steps including the lens unit below and strips lights. A lens unit can include nine lenses. Each lens can distribute the light from a pcb board “cob” fitted with LED diodes.

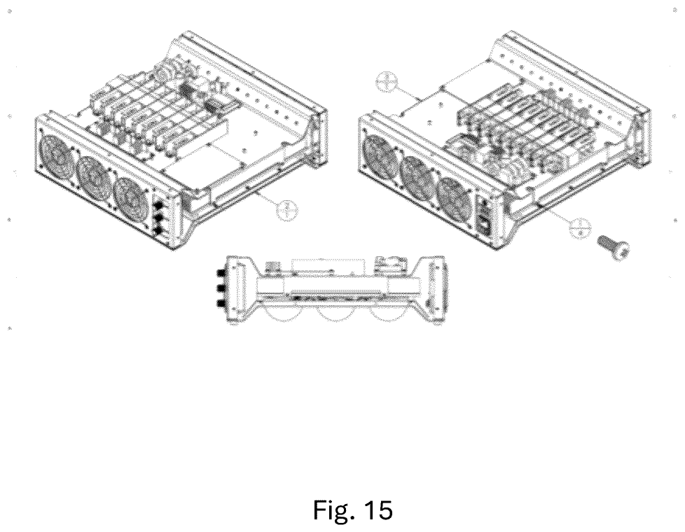

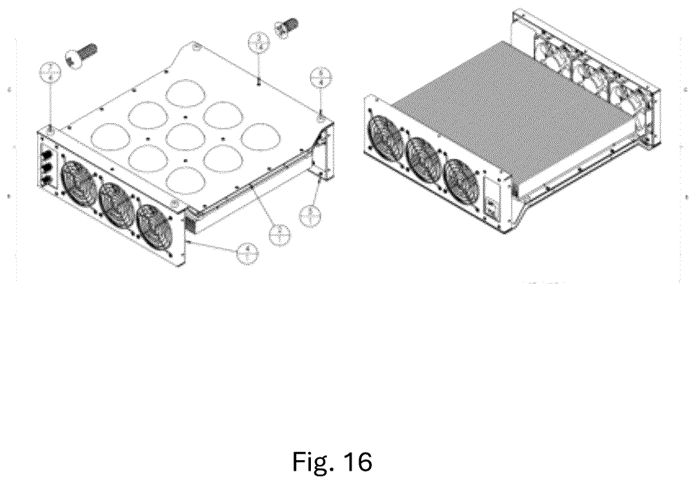

As shown in FIGS. 15 and 16, each lighting unit can include complete thermal cooling LED drivers on board. There can be three potentiometers on the outside that allow the intensity of the various groups of LEDs to be changes as a group. The units can include five channels in total with three adjustable.

The exemplary lighting cobs can provide a relatively simple and inexpensive way of creating a very large number of narrow band frequency combinations and using them in a common housing. The cob could split the LEDs into five channels of driver supplied power and intensity settings.

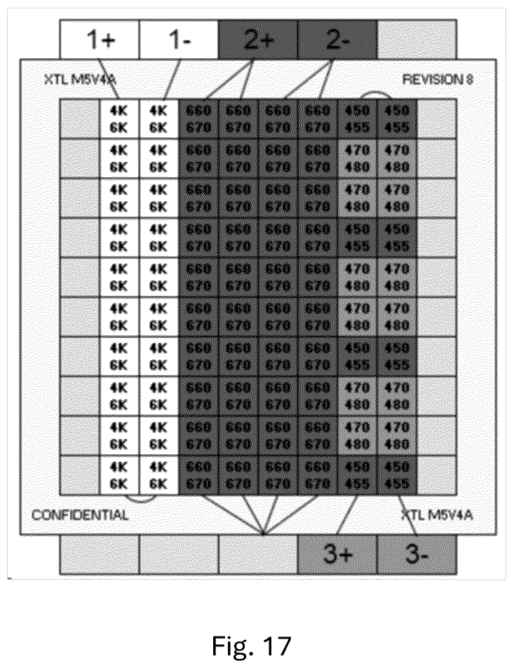

FIG. 17 shows an example of an M5V4A Revision 8 LED Cob.

| | | |
|---|---|---|
| A/B | B/A | A/B |
| B/A | C | B/A |
| A/B | B/A | A/B |

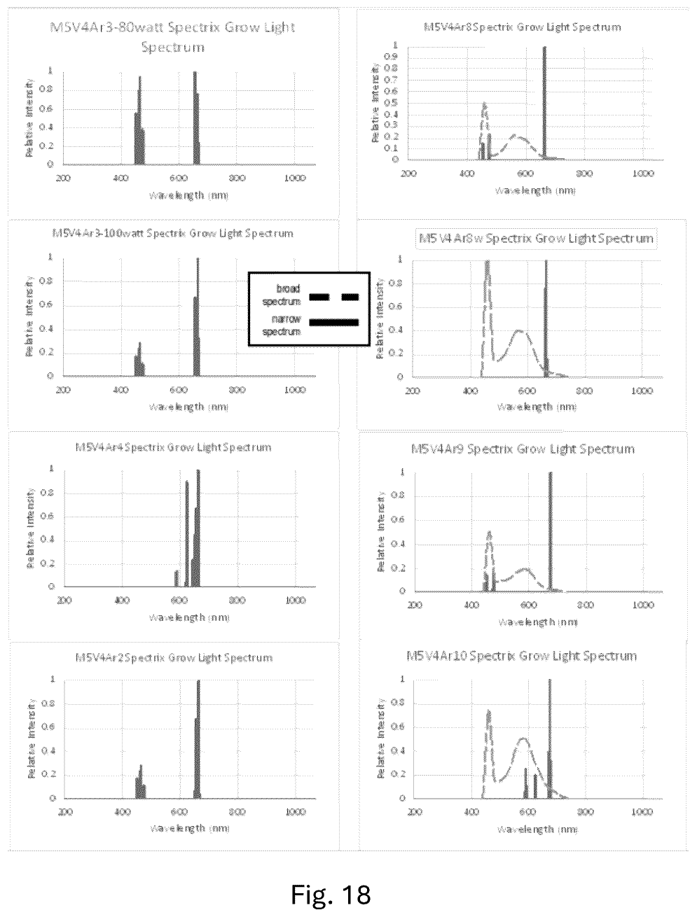

The above table/figure shows possible LED Cob Arrangements. The cobs can be designated “A”, “B”, or “C”. “A” and “B” cobs can be on the outside of the array and “C” cobs can be placed in the center of the array. The evolution of the lighting cob frequency combinations has been documented with the central frequencies of the LEDs used, number of LEDs of each frequency, the voltage, current, watts, and the relative intensity of each frequency on the cob compared to the other frequencies present. A sample of this documentation for the cob M5V4A revision 8 is shown in FIG. 18.

Specifically, FIG. 18 shows Spectral Evolution of the M5V4A Light Cob.

Each of the cob spectra and grow test results can be linked, in a database, to the current 28 known trigger frequencies and characterized by photoreceptor combinations and outside research into metabolic behavioral results correlated by cob frequencies. This is the beginning of the knowledge base for lighting AI.

White LEDs can be included for maintenance lighting and, to cover frequencies not yet identified as necessary. A number of experiments started out with negative plant responses to narrow-beam only lighting because frequencies that stimulate the primary metabolic system may not be included in the original test configuration. In those case the white levels can be iteratively adjusted to determine the minimum consistent with plant growth.

The LED cobs on the outside of the unit can be oriented to cause the widest and most even distribution of the narrow beam energy over the “grow-frame” The plant area illuminated by the lighting fixture at a designed distance below the lighting fixture. Basil Research

### Basil Test Descriptions

One goal was to determine the growth efficiency of Basil plants under varying light configurations compared with high pressure sodium light. Results were expressed in grams of plant biomass and grams biomass per lighting watt.

High pressure sodium (HPS) lights were the standard at the time and the plant growth performance under HPS was well known. This allowed an independent check of the HPS plants as a control group for comparison.

There were two grow chambers. Grow chamber 1 was equipped with a grow light made in accordance with principled of the disclosed subject matter (the exemplary light), and chamber 2 was equipped with a high end 600 watt HPS bulb. The HPS light was set to 490 watts to provide adequate light intensity. The exemplary light was set at 365 watts to provide approximately the same light intensity as measured by PSAR meter.

The two lights have inherently different spectral distributions with predominantly yellow light coming from HPS and predominantly white light from the exemplary light. Both chambers were fed from the same air filtration and cooling system and nutrient water reservoir.

### Basil-1 Description

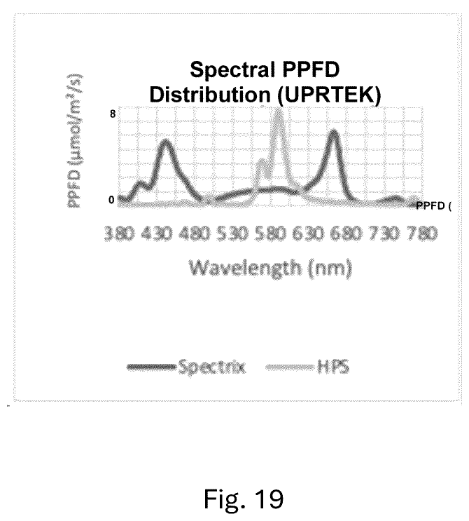

Compared the growth results of Basil plants grown under the spectrum of a high pressure sodium (HPS) lamp and those grown under an exemplary light 1A LED spectrum. FIG. 19 shows the two spectra as measured by an Uprtek spectrophometer are compared. This experiment compared Basil plants grown under different light spectra. Grow chamber 1 was equipped with an exemplary light grow light and chamber 2 was equipped with a high end 600 watt HPS bulb. The HPS light was set to 490 watts to provide adequate light intensity. The exemplary light was set at 365 watts to provide approximately the same light intensity as measured by PSAR meter. The two lights have inherently different spectral distribution with predominantly yellow light coming from HPS and predominantly white light from the exemplary light. Both chambers were fed from the same air filtration and cooling system and nutrient water reservoir, the only variable was grow light power consumption and spectrum. The lighting intensity and spectra was constant over the illumination period for both chambers.

### Basil-2 Description

Same physical setup but used narrow-band lighting and a dynamic lighting control of the exemplary light that changed the narrow band spectrum offered as a function of the time of day.

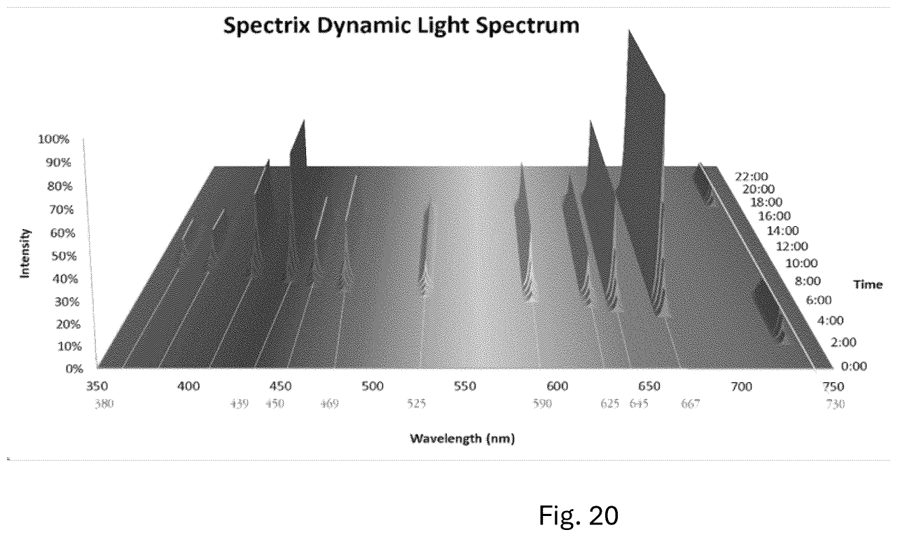

The most significant time of day difference is the use of 730 nm light before and after the period of photosynthesis stimulation. The spectral changes as a function of time are shown in FIG. 20, which shows a dynamic spectrum.

### Basil Results

The results of the three sets of tests show a remarkable difference in plant response to changes in the content and dynamics of the lighting systems.

### Basil-1 Results

After 48 days under the grow lights, 10 plants were harvested from each chamber and weighed. Fresh mass represents the total weight of all 10 plants after being separated from their roots. Dry mass was measured after letting the plants dry in paper bags for 10 days. Efficiency was calculated by dividing mass by the light energy consumption. Any difference in the cost of cooling was not included.

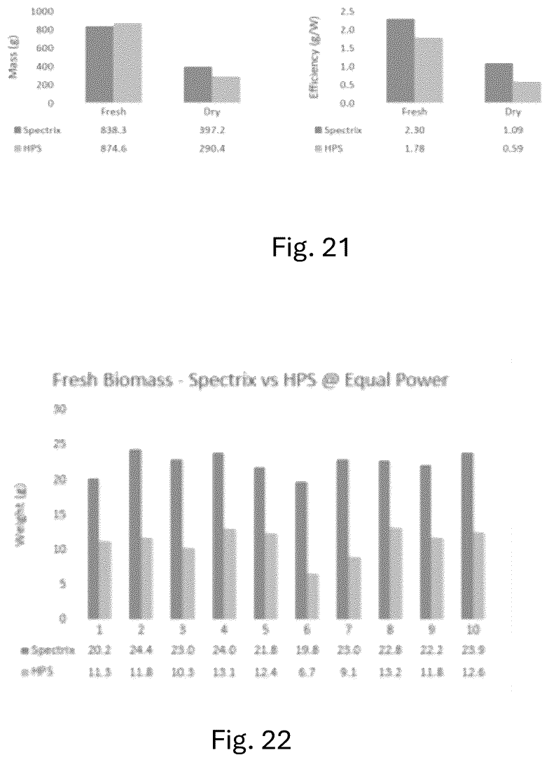

FIG. 21 shows Grow Mass and Efficiency per Watt.

Exemplary light plants grew almost the same fresh plant mass as HPS using about 25% less energy which equals 130% mass per watt. After drying, exemplary light plants weighed 37% more than HPS plants which equals 184% mass per watt. Plant leaves were sent to the lab for analysis which showed the exemplary light plant's leaves contained slightly higher levels of most nutrients. Considering that less energy was used to produce the exemplary light plant's leaves, average nutrient production in mg/W was calculated to be 100% more under exemplary lights compared to HPS lights.

### Basil-2 Results

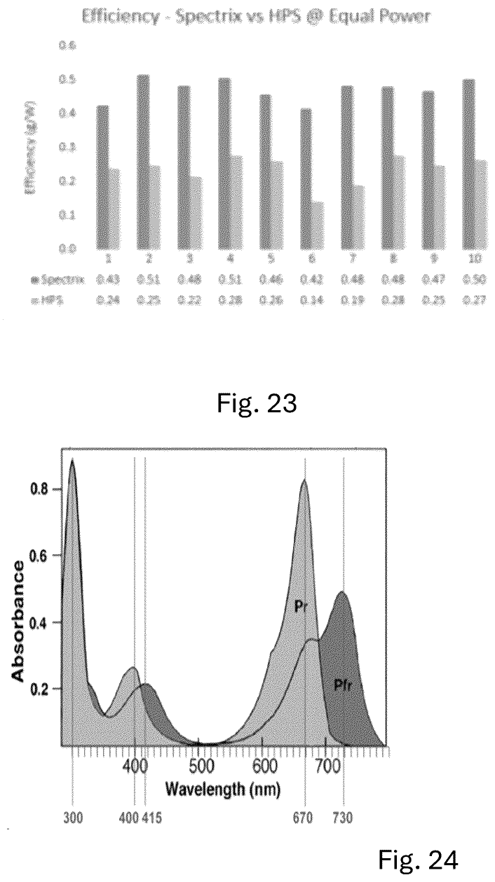

As shown in FIGS. 22 and 23, the results from the dynamic control of the light as a function of the time of day reveal a huge difference in plant response. The of 730 nm light before and after the provision of photosensory active radiation (PSAR) doubled the growth response of the plants.

The plants were grown in the same tray spots relative to the light source so the incident light intensity for each test pair were the same.

### Basil Result Analysis

The results of the three sets of tests show a remarkable difference in plant response to changes in the content and dynamics of the lighting systems.

The Basil-1 results show a near parity in fresh biomass between exemplary light 1A continuum and HPS. This is a reasonable indicator that current lighting systems with optimized continuous spectra produce more dry vegative biomass but not much more fresh plant mass. The Basil-2 results show the fresh biomass as double that of the HPS and, therefore, optimized continuous lighting results. This result indicates a number of significant issues have been impacted.

There can be as few as two or even one narrow band light signal that is the trigger for a specific metabolic response. This meant that the presence of narrow band light was the only consideration and test criteria. The metabolic processes regulating photosynthesis are for the provision of energy for all metabolic chemical reactions accompanied by the stimulation or retardation of the primary metabolism (main plant growth process for growth gene expression).

Hormone, protein, and regulatory photoreceptors such as phytochrome, photochrome, and cryptochrome photoreceptors, together, form a tree of decision points for the primary metabolism that allow the plant to respond to its environment. These decision points are not only dependent upon the presence of narrow band signals but also their absence. This is a powerful point. Everybody is busy adding light spikes but no one has figured out that subtracting can be just as important. Tests often do not determine whether the colors work with continuous spectra present-they often do not.

For example, the phytochrome Pr to Pfr to Pr cycle involves combinations of two specific trigger frequencies and the same two frequencies as absent. One of the trigger frequencies (660 nm) is also a main photon contributor to photosynthesis in chlorophyll-A.

As shown in FIG. 24, the Pr Phytochrome has its maximum absorption at 730 nm and a minor max at about 670 nm. The Pfr has its max absorption at 670 nm and is not sensitive to 730 nm light at all. The presence of 660 nm light and the absence of 730 nm light is one trigger state (high growth). The strong presence of 660 nm and weak presence of 730 nm yields moderate growth. The presence of strong 730 nm light and the absence or weak 660 nm light is a trigger for a low growth state. The change to the phytochrome by the presence of light is a change in several of its molecular bonds that changes molecular shape (opens and closes a ring) and its chemical bonding signature causing it to have two distinct signaling pathways depending on the molecular shape.

The absence of both forms a third trigger state, circadian dark cycle or rest state growth. Once a basic speed equilibrium is set, the actual plant response is further modified by hundreds of other combinations of the 28 currently identified triggers (primary and secondary metabolic pathways)

This is one of the key issues about not having a continuous spectra and no continuous or a low intensity continuous spectra that is below the activation intensity of high level triggers. The whole conceptual basis of light design and horticultural control is currently based upon variation of continuums without the acknowledgement of the need to cut out or lower the intensity of some of the bandwidth or some frequencies for modifying certain desired metabolic responses.

In order to create absence the whole continuous spectrum can be changed in an attempt to create “optimized sunlight” and diurnal effects without a mechanism for direct control and expression that we acquire by a single basic blackout or low intensity continuum with narrow to moderate band light sources in combinations of intensities and absent (third state) frequencies as triggers.

Many of the phototropic signals are in fact combinations of narrow band light presence in one frequency and absence or low intensity in another. Here is the lower frequency end of the actual spectra offered. The 667 and 730 nm trigger biomass accumulation speed while the 667 nm also drives high rate photosynthesis in tandem with high growth rate behavior.

The blue high-frequency photosynthesis narrow-band for both chlorophyll-A and chlorophyll-B is also needed for high growth rates.

Narrow band trigger effects, where they do not have a continuum. The effects observed can be in part due to the plants' lack of other triggers that would have suppressed the results.

### Basil Analysis of Metabolic Trigger Control

The actual importance of the diurnal trigger pattern in Basil-2 is that it is a demonstration of a management process according to the present disclosed subject matter. The LEDs at 667 nm and 730 nm are known to control a number of metabolic plant processes through phytochrome/cryptochrome signaling.

The Pr and Pfr states of Phytochrome photoreceptors are signals that regulate the speed of plant growth processes. Pr inhibits and slows down plant growth. Pfr speeds up and intensifies plant growth processes. The exposure to 730 nm light causes the Pfr phytochrome to immediately turn into a Pr phytochrome. When Pr phytochromes are exposed to 667 nm light they turn into Pfr phytochromes.

We can now see how the control of this signaling process by light frequency availability resulted in some of the directly observed results in terms of greatly increased biomass per illumination period. The following graphics and explanation, based on photomorphogenic research, explains what happened and the narrow-band lighting guarantees that there were no other signals present.

The Pr and Pfr states of Phytochrome photoreceptors are signals that regulate the speed of plant growth processes. Pr inhibits and slows down plant growth. Pfr speeds up and intensifies plant growth processes. The exposure to 730 nm light causes the Pfr phytochrome to immediately turn into a Pr phytochrome. When Pr phytochromes are exposed to 667 nm light they turn into Pfr phytochromes.

### The Calculation of Pr/Pfr Equilibrium Intensity

The phytochrome photostationary state (ϕ) is the equilibrium mix of Pr an Pfr states associated with a narrow band light source center frequency. The phytochrome photostationary state (ϕ) is established by multiplying the irradiance (N) at each wavelength (λ) against the relative absorption at that λ for each form of phytochrome [the photochemical cross-sectional area (σ)] and calculating ϕ using the following equation:

$$Φ = [ {\sum }_{800}^{800} {N}_{λ} {σ}_{r λ} ] \div [ {\sum }_{800}^{800} {N}_{λ} {σ}_{r λ} = {\sum }_{800}^{800} {N}_{λ} {σ}_{fr λ} ] .$$

Typical values of ϕ under ambient solar conditions are ϕ=0.6 for full sun and ϕ=0.1 for dense shade under a full canopy, although these values vary according to canopy type and density.

The range of values from electric light sources vary from ϕ=0.1 from a far red rich light source to ϕ=0.89 from a source with high red spectrum are actually the equilibrium mix of Pr/Pfr growth speed signals.

The values for estimating ϕ derived from isolated phytochrome are useful guides to determining the effect of any light source on the phytochrome response.

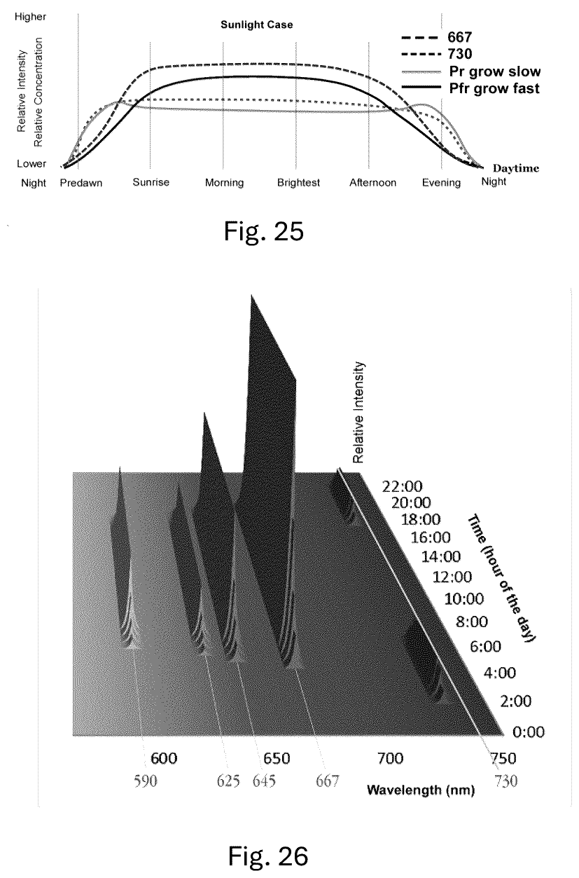

When using narrow-band LEDs, the ϕ can be approximated based on the λ max of the LED. The estimate of ϕ for discrete narrow-band LEDs with λ max from 300 to 800 nm. Relative quantum efficiency (RQE) for photosynthesis can be measured to allow the photosynthetic efficiency of a given wavelength to be evaluated as well. These well-defined parameters allow the spectra to be optimized for both photosynthesis and photomorphogenesis. FIG. 25 shows Phytochrome Cross-section Values.

### Sunlight

In the early morning when the plant is exposed to far-red-light and almost no or limited 667 nm red-light, the population of phytochrome Pr increase and the levels of Pfr decrease.

Due to the minor 670 nm absorption peak in the Pfr photochrome a certain amount of Pfr is converted to Pr (go slow) by the light that is otherwise the power behind both photosynthesis and the stronger photochrome response to Pfr (grow fast)

As the morning continues the relative strength of 670 nm light dramatically increases so the population of Pfr (grow fast) is dramatically increased yet tempered by the same light causing a moderating reverse of Pfr back to Pr. Eventually, a type of equilibrium state emerges. But the gap between the go fast and go slow signals is strongly moderated by the relatively high total energy a continuous spectrum affords the Pfr->Pr transition.

FIG. 26 shows the GLAB-2 Case.

The Case used narrow band light and a diurnal pattern where the 730 nm light was provided in the morning from 2:00 am to 8:00 am and in the evening from 18:00 μm to 22:00 pm. Except for these two periods there was no 730 nm light present in the closed grow environment. From 6:00 am to 18:00 pm narrow band light centered at 667 nm with greater than 50% of its photonic energy between +/−5 nm of the center frequency. At 7:00 and 8:00 am narrowband light with center frequencies of 625 nm and 645 nm.

This lighting pattern use and exclusive supply of 730 nm light to push a larger amount of Pfr into the Pr state. Since Pr is sensitive to 670 nm light and is converted to Pfr by its presence, loading the plant with an excess of Pr sets up a more intense Pfr signal wave (grow quickly trigger) as PSAR radiation hits the plant.

When the lights change and hold state there is a larger relative Pr population than the Sunlight Case that transfers into the Pfr state. Further because the is no energy outside the 10 nm bandwidth at 667 nm except for the other two 10 nm light at 625 and 645 that also provide stronger Pfr state population growth.

Since Pr is sensitive to 670 nm light and is converted to Pfr by its presence, loading the plant with an excess of Pr sets up a Pfr wave (grow quickly trigger) as PSAR radiation hits the plant.

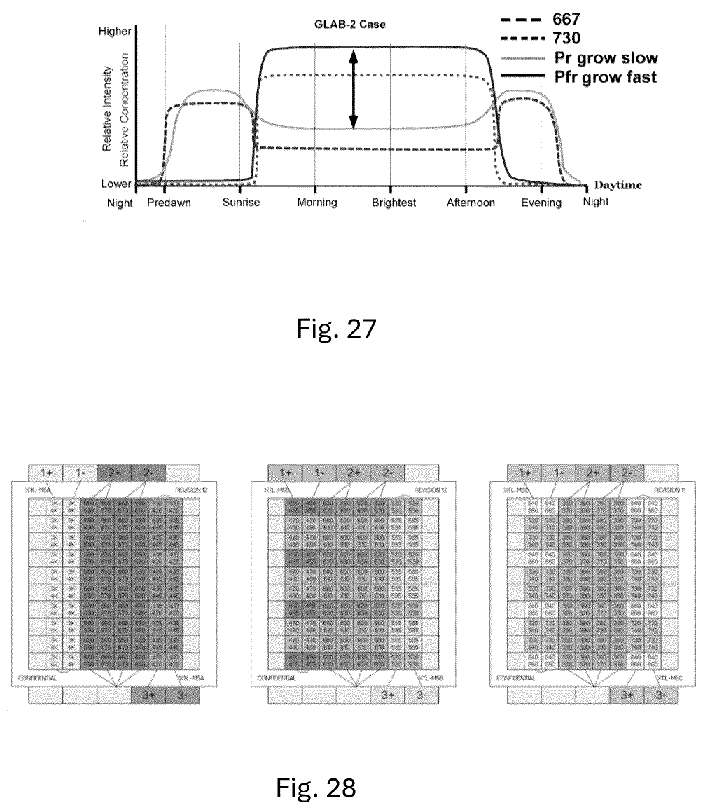

FIG. 27 shows Phytochrome Response to Narrow Band Trigger.

As the intensity of the red-light increases with respect to the far-red-light, the levels of Pfr increase until both a much stronger Pfr (fast grow) signal population and lower Pr (grow slow) phytochrome signal population equilibrium is reached than the sunlight case.

This explains the Basil-2 results where the plant growth stimulus has been triggered into high growth. It also explains why the continuum can't replicate this. There are hundreds of secondary and other metabolic triggers like hormones that impact primary metabolic response but are not triggered because we are not providing signal noise.

| Action mode | Fluence Requirements | | Photoreversibility | Reciprocity |
|---|---|---|---|---|
| VLFR | 0.1 μmol/m²-1 μmol/m² | | No | Yes |
| LFR | 1-1000 | μmol/m² | Yes | Yes |
| HIR | >1000 | μmol/m² | No | No |

VLFR: very-low-fluence response;
LFR: low-fluence response;
HIR: high-irradiance response.

### Table: Phytochrome Response To Intensity

As the sun begins to set in the evening the levels of far-red-light begin to increase with respect to red-light and the concentrations of Pr begin to increase causing slow-down in plant growth processes before sunset and triggering circadian time responses.

(a) the red: far-red ratio provides a reliable signal of plant density, even before shading by neighbors occurs: (b) plants are able to perceive and respond to these signals, and that possible ambiguities due to low red: far-red at low solar angles may be avoided by modulation of the perception process by fluence-rate dependent mechanisms. “[4] In other, words, using specific bands of light in the red and far-red.

However, the Phytochrome signaling process is also intensity sensitive. Table 2 reveals that there are three generally accepted states of fluence (In general physics fluence is defined as the time-integrated flux of optical energy delivered per unit area such as the light intensity measurement standard PFE in horticulture).

Very Low-Fluence Response (VLFR) are activated by extremely low light intensities of different wavelengths (FR, R and B); examples include light-induced expression of the light-harvesting chlorophyll-a/b-binding protein (LHCB) gene and light induction of seed germination. Low Fluence Response (LFR) is the reversible Pr-Pfr growth control process.

LFRs also induce other transient responses, such as changes in ion flux, leaf movement, chloroplast rotation, and changes in gene expression within the plant. When irradiated above 1,000 micromol/m², a High Intensity Response (HIR) occurs and this signaling process stops. This is a critical point to narrow-band illumination. The current industry is trying to get to 3000 micromol/m² and above with broad band radiation in the photosynthetic regions. All the signaling frequencies and the photosynthetic frequencies are inundated with broadband light. In the narrow-band experiments the photosynthetic frequencies had peak lighting but so did signaling frequencies without overloading intensity.

The current explanation in the CEA industry of the observed plant shutdown under intense LED lighting is the plants have to rest. In fact, what has happened is the broadband intensity triggers an HIR (lutein hormone) metabolic response that that caused the growth signaling to stop and damage protection processes to start.

The narrow-band opportunity is the irradiation of the photosynthetic processes so that metabolic signaling is controlled and growth is stimulated in a way that broad band illumination cannot. For example, by using these two colors in combination with narrow-beam stimulation of photosynthesis unique growth patterns can be achieved.

Broad-spectrum bright natural sunlight often overpowers the desired energy quantities the plant can use and causes heat build up, phototropic tissue damage, and photoreceptor initiation of growth reduction and other protective measures. With narrow-band illumination much higher levels of direct stimulation can be achieved without the negative energy effects.

There can be as few as two or even one narrow band light signal that triggers a specific response in the presently disclosed subject matter.

The metabolic processes regulating photosynthesis are for the provision of energy for all metabolic chemical reactions accompanied by the stimulation or retardation of the primary metabolism (main plant growth process for growth gene expression).

Hormone, protein, and regulatory photoreceptors such as phytochrome, photochrome, and cryptochrome photoreceptors, together, form a tree of decision points for the primary metabolism that allow the plant to respond to its environment. These decision points are not only dependent upon the presence of narrow band signals but also their absence. Everybody is busy adding but no one has figured out that subtracting is just as important.

For example, the phytochrome Pr to Pfr to Pr cycle involves combinations of two specific trigger frequencies and the same two frequencies as absent. One of the trigger frequencies (660 nm) is also a main photon contributor to photosynthesis in chlorophyll-A.

The presence of 660 nm light and the absence of 730 nm light is one trigger state (high growth). The strong presence of 660 nm and weak presence of 730 nm yields moderate growth. The presence of strong 730 nm light and the absence or weak 660 nm light is a trigger for a low growth state. The absence of both forms a third trigger state, circadian dark cycle or rest state growth. Once a basic speed equilibrium is set, the actual plant response is further modified by hundreds of other combinations of the 28 currently identified triggers (primary and secondary metabolic pathways)

This is one of the key issues about not having a continuous spectra and no continuous or a low intensity continuous spectra that is below the activation intensity of high level triggers. The whole conceptual basis of light design and horticultural control is currently based upon variation of continuums without the acknowledgement of the need to cut out some frequencies for certain desired responses

In order to create absence we can change the whole continuous spectrum to alter reduce or change the intensity of triggers without a mechanism for direct control and expression that we acquire by a single basic blackout or low intensity continuum with narrow to moderate band light sources in combinations of intensities and absent (third state) frequencies as triggers.

Many of the phototropic signals are in fact combinations of narrow band light presence in one frequency and absence or low intensity in another. Here is the lower frequency end of the actual spectra offered. The 667 and 730 nm trigger biomass accumulation speed while the 667 nm also drives high-rate photosynthesis in tandem with high growth rate behavior. The blue high-frequency photosynthesis narrow-band for both chlorophyll-A and chlorophyll-B is also need for high growth rates (simply a need for high growth rate energy).

### Basic Grow Structure Setup

A basic grow-rack has one or more levels arranged vertically where each level is 4 feet by 8 feet in area or 32 ft² or 2.97289728 m².
The current advised growth density for basil plants is 40 plants per m².
Current yields per harvest under superior conditions are 5.5 kg/m² or 12.2 lbs/m².

### Tomato Research

Tests on tomatoes were conducted with several different light arrays. The first test series of significance focused on the comparison of “red” and “blue” spectra at two intensity levels. The second series were tests done in grow-chambers and were focused on determining the role specific role intensity has on optimizing tomato results.

### Tests

The experiments sought to determine how the spectral distribution of exemplary lights influence the growth of early girl tomato fruit mass. Results were compared to show the differences in crop quality, quantity, and energy efficiency between exemplary light and HPS lights.

### Test Descriptions

Grow-chambers were set up as light excluding environments. Each grow-chamber had a lighting unit placed in the center of the chamber roof positioned 36″ above the plants. There were two groups of grow-chambers. Group one grow-chambers included two chambers with exemplary light Units (A900-A1: having different spectra. One unit's spectra was more “red” and the other was more blue” A third chamber had a High-Pressure Sodium (Gavita 600e SE-HPS1) lighting unit configured with equal photonic intensity adjusted to 625 Watts. Group two had the same lighting unit contents but adjusted to use have 20% less electrical power in Watts. The Lighting Units

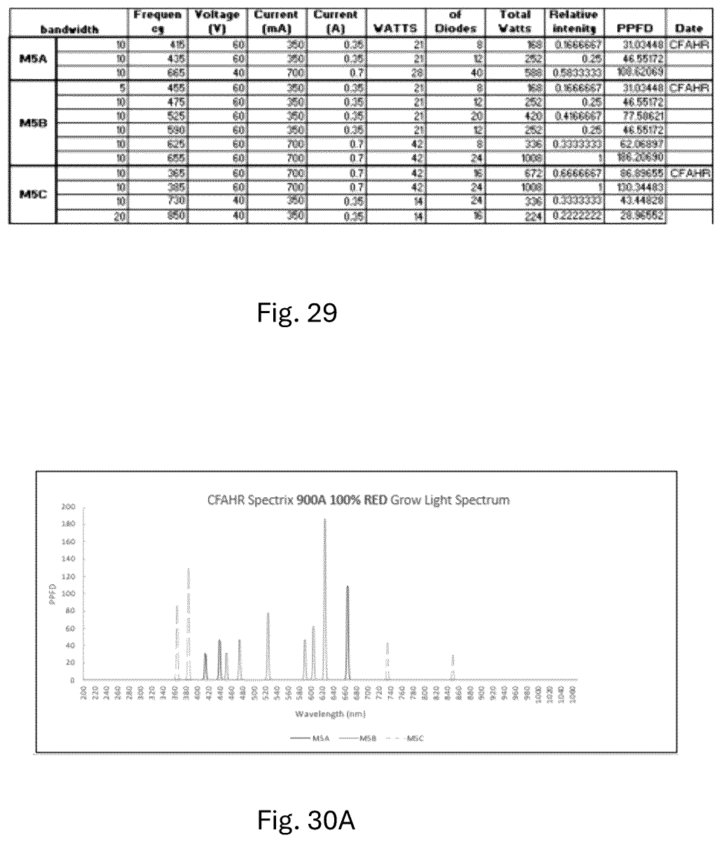

The exemplary light A900-A1 red lighting unit has three LED cobs M5A, M5b and M5C containing LEDS as shown in FIG. 28. The table of FIG. 29 shows LED and Driver Specifications Used.

The Photosynthetic Photon Flux Density (PPFD) measurement of the amount of photosynthetically active photons that reaches a plant, expressed in micromoles per square meter per second (μmol/m²/s), for each LED type within the cobs used are given above. When combined in a lighting unit, the intensities per frequency were adjusted by driver to a default setting set in the following table. The M5A had 20 3-5K white LEDs for use during maintenance and visual plant inspection. They were not illuminated during the test periods.

The maximum PPFD was obtained by direct measurement of the integral photon density of all the LED spikes. An UPRTEK Spectrophotometer was used to take this measurement.

With the measured total PPFD intensity and the wattage per LED a calculation of the PPFD per LED frequency was made resulting in the following spectra. The total PPFD of the blue spectra was 1023 μmol/m²/s and the “Red” spectra was 1050 μmol/m²/s.

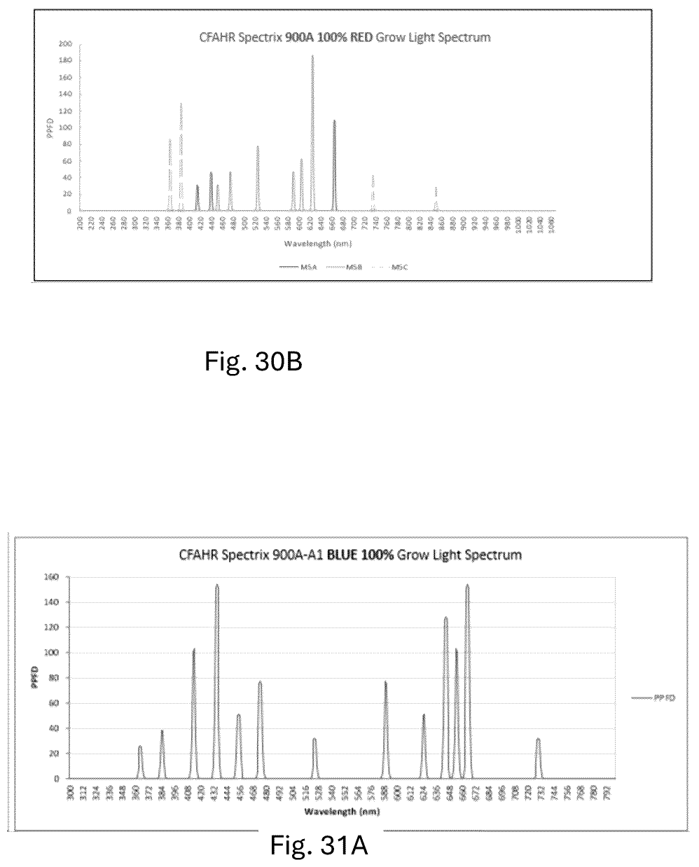

FIGS. 30A and 30B depicts A1 100% v. 80% Spectra, respectively.

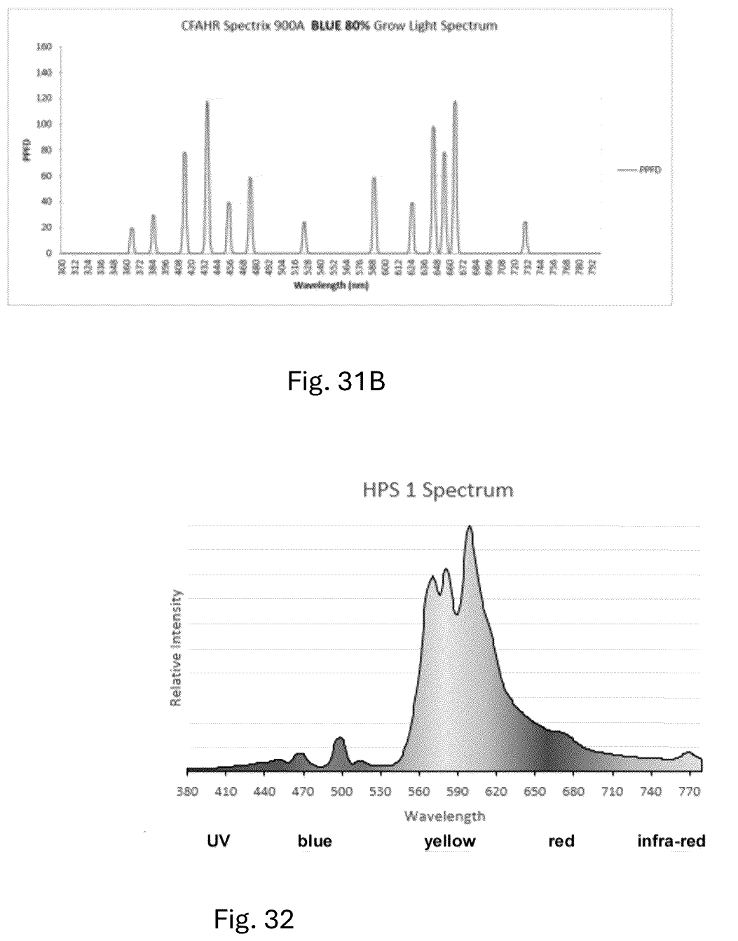

FIGS. 31A and 31B depict B1 100% v 80% Spectra, respectively. FIG. 31B shows the ideal light recipe for promoting tomato growth.

### Grow-Chamber Lower-Bound

The grow-chambers were isolated from outside light entry and the ambient penetration of daylight was measured to be less than 3 μmol/m²/s and this was considered the lower bound (level of foreign light intrusion that would make no difference in the test results) for the test, since it was within the margin of error for the intensity measurements being done, exemplary lights include Spectrix A1, B2, A2, B2:

### PPFD Intensity and Grow-Tray Location

Each grow-chamber supported grow-trays located so that the trays in each grow-chamber had a series of labelled locations representing specific levels of spectral light intensity relative to the red/infrared cobs that surrounded the central UV cob in the exemplary light lighting units.

The PPFD intensity distribution 36 inches directly below the lighting units, show how the plants in a given grow-chamber were provided a number of different intensity variations based upon the plant's location in the grow-tray. All the individual plant data were recorded by plant position.

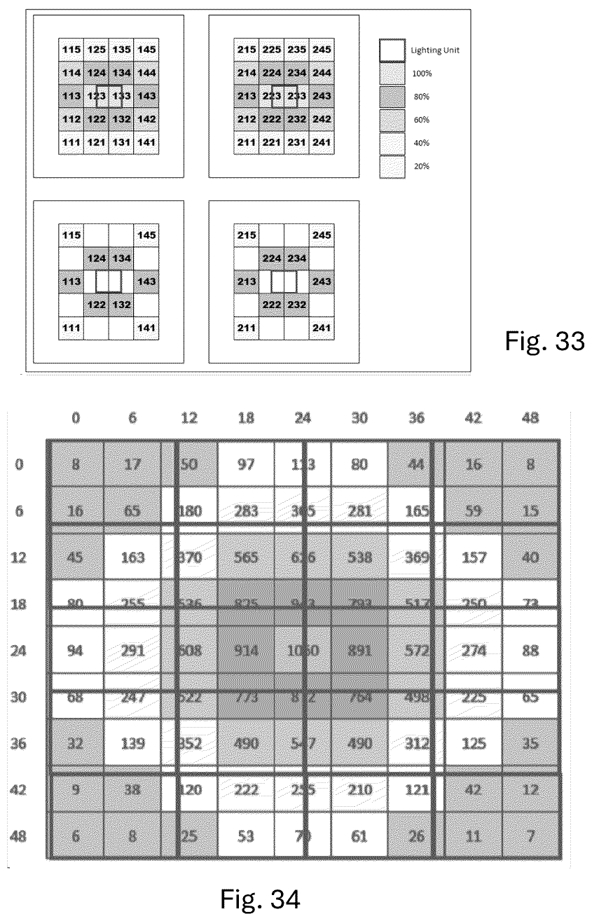

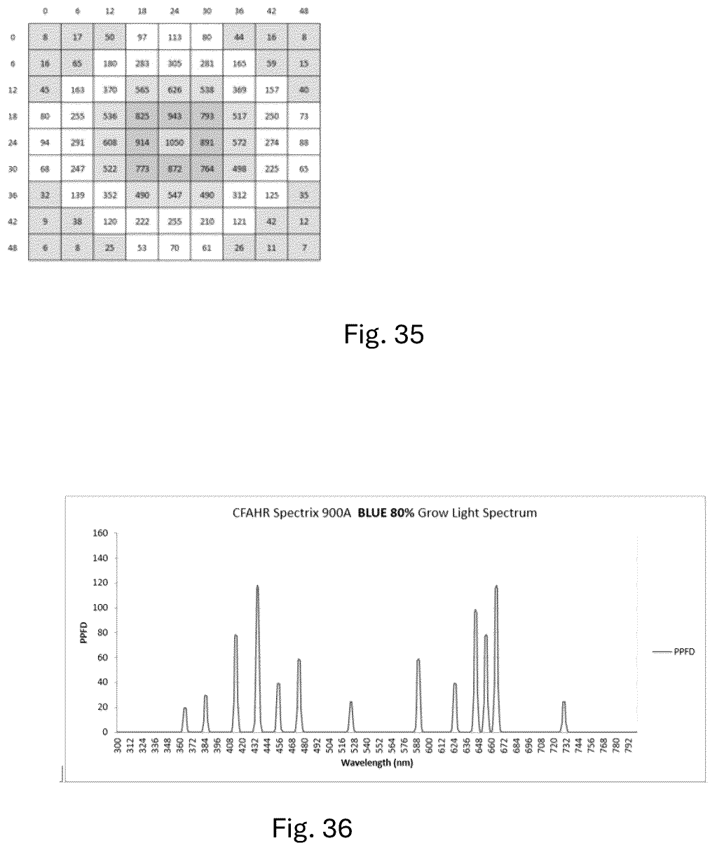

The location diagram of FIGS. 33-35 shows the measured PPFD intensity 36 inches below the lighting unit as a function of location. The plant growing locations were then overlayed on the intensity distribution and the resulting test locations were assigned to five bands of roughly 20% intensity drop.

### Nutrients

Grow-trays were flooded for 10 minutes at a time, once per day during the first half of the crop cycle and twice per day during the second half of the crop cycle. Water reservoirs were kept within a temperature range of 70 to 75° F. and pH range of 5.8 to 6.2. Every week, water and nutrients were replenished to EC 3.0 and pH 6.

| Plant | pH | cF | EC | PPM |
|---|---|---|---|---|
| Tomato | 5.5-6.5 | 20-50 | 2.0-5.0 | 1400-3500 |

The pH and EC of water in each reservoir were maintained to provide crop requirements listed in the nutrients table. Dyna Grow liquid fertilizer was provided to maintain an EC of the water and nutrients between 2.0 mS to 3.0 mS. The pH was maintained at pH 5.8 with phosphoric acid. Plant specific pH and nutrient levels referenced from a database. Sampling

Destructive sampling was done at 3 points throughout the experiment. The timing was different for each type of plant. Destructive sampling was done at three points throughout the experiment at three Evaluation Times (Eval. Time). The first was at 40 days (flower set), the second was at 90 days (fruit set) and the third was at 120 days (harvest).

Tested leaf chlorophyll throughout the experiment using a Minolta SPAD 502 with biweekly recordings. Also quantified biomass and root shoot ratios with each destructive sampling, reported as fresh weight and then dried in an oven and reported as dry weight. Plant quality was evaluated by looking at 10 different metrics and rated for commercial viability. Photographs of each plant were taken at terminal uprooting.

### Results

Results from Tomato “Early Girl” trial. Over the trial yield and quality were assessed for all six light spectra. The yield and quality results were evaluated with statistical software (SAS 9.2) for analysis of variance. The means were separated using Tukey's LSD for statistical difference between Treatment*Eval. Time. Treatments with the same letter are not statistically different. “An advantage of the Tukey LSD (Least Significant Difference) test is to keep the level of the Type I error (i.e., finding a difference when none exists) equal to the chosen alpha level (e.g., α=0.05 or α=0.01).”⁸⁷ An additional advantage of the Tukey test is to allow the computation of confidence intervals for the differences between the means.

The first and most notable result was that the tomato plants flourished under both narrow band spectra lighting compared to high pressure sodium. The narrow band Blue 80% light overall provided the best performance and the highest efficiency (result per Watt).

A number of interesting and unusual result occurred. In tray one (Red 100%) adventitious roots appeared in the flower stems of tomato plants. While high pressure sodium produced and early fruit, those fruit ripened very slowly compared to the narrow-band behavior.

Reviewing the results it is interesting to note that the 80% blue light produces the best overall results. All of the narrow band narrow lights outperformed high-pressure sodium.

| | Fruit | Grow | Fruit | Flower | Fruit | Fruit | Density | |
|---|---|---|---|---|---|---|---|---|
| Light | Yield | Efficient | Set | Count | Weight | Count | Biomass | AVG. |
| 100% Red | 1 | 2 | 1 | 2 | 1 | 3 | 2 | 1.7 |
| 100% Blue | 2 | 3 | 2 | 2 | 3 | 2 | 4 | 2.3 |
| 100% HPS | 5 | 4 | 3 | 3 | 6 | 4 | 5 | 4.3 |
| 80% Red | 3 | 3 | 4 | 1 | 2 | 5 | 3 | 3 |
| 80% Blue | 1 | 1 | 1 | 1 | 4 | 1 | 1 | 1.4 |
| 80% HPS | 4 | 5 | 5 | 4 | 5 | 6 | 6 | 5 |

### Analysis—The Blue Spectrum

The blue spectrum frequencies are mapped to the following photoreceptors.

| nM | Photoreceptor |
|---|---|
| 365 | Zeitlupes |
| 385 | ELIP/Resin |
| 395 | violaxanhin |
| 405 | Phot1, Phot2, UVA |
| 415 | Pfr, UVA |
| 420 | violaxanhin, neoxanthin, lutin, UVA |
| 430 | Chlorphyll-a. |
| 435 | Chlorphyll-a, |
| 440 | CR1, CRY2 Chlorphyll-a |
| 450 | FKF1, zeaxanthin, neoxanthin, violaxanhin, CRY2, beta-carotene |
| 455 | beta-carotene |
| 458 | Phot1, Phot2 |
| 473 | neoxanthin, phototropin |
| 475 | beta-carotene |
| 480 | beta-carotene |
| 490 | cryptochrome, phytochrome |
| 525 | phototropin, cryptochrome, phytochrome |
| 530 | green flourenscnse |
| 576 | Phycoerythrins |
| 590 | reduction in chloroplasts, fruit ripening. Phycoerythrin |
| 618 | Phytocyanins |
| 625 | tomatoe biomass, Phycocyanin |
| 642 | Chlorophyll-b |
| 645 | Chlorophyll-b, Chlorophyll-c |
| 650 | Chlorophyll-b, Allophycocyanin |
| 655 | Chlorophyll-a |
| 660 | Chlorophyll-a |
| 665 | Chlorophyll-a |
| 667 | Phytochrome Pr |
| 680 | Chlorophyll-a flowering |
| 730 | Phytochrome Pir |

The 400 to 500 nm Blue band and 430 nm Blue

Since testing was done, the role of blue light frequencies have on tomato plant and fruit growth have been documented and provide support of the fact that single narrow-band light sources directly stimulate signaling pathways and therefore both the primary and secondary metabolisms of plants.

It is noteworthy that blue LED light enhances secondary metabolites in plants, including ascorbate, total phenolic, anthocyanin, flavonoid contents, and antioxidant activity. Blue light is more efficiently absorbed by photosynthetic pigments than other spectral regions. Supplemental blue light promoted early tomato flowering and fruit color change and had a significant effect on the accumulation of lycopene. Supplemental lighting was blue LEDs (430 @ 10 nm, Chenghui Equipment Corporation Ltd., Guangzhou, China). The supplementary light intensity was set uniformly at 100 μmol/m²/s.”⁸⁹

Different frequencies of supplemental blue light (415-475 nm) could accelerate flowering of tomato plants, dramatically increase the ethylene production, promoting fruit ripening about 3-4 days ahead, which significantly facilitated the processes of color change and maturity in tomato fruits.

Higher nutritional and overall sensory profiles of tomato fruits were detected in supplemental blue light treatments, with a significant increase in the contents of lycopene, total phenolic compounds, total flavonoids, vitamin C, and soluble sugar, as well as the overall antioxidant activity of tomato fruits.

### Combined Photoreceptors

The LED frequencies chosen in the research experiments are a close map to the specific photoreceptors that in combination regulate the behaviors observed. During the testing a very large number of frequency combinations were tried on species important to horticulture.

As a result, mapping of color combinations resulted from observed success in creating improved growth behavior. While the original intent was to reduce the energy consumption in lighting provided for photosynthesis, the actual discovery is that specific narrow-band frequency combinations result in specific metabolic signaling pathways that, in fact, regulate how the plant uses photosynthetic energy during growth. The following table reviews a few of the interactions and the principal research that resulted in their formal identification.

Each of these combinations are found in the frequencies chosen in present disclosed subject matter with results observed being caused by their excitation. The excitation of the photoreceptors has been increased in third party research to include how photosensitive hormone and enzyme pathways also affect plant growth as well.

Narrowband Only Vs. Supplemental Narrowband

The research produced results where the fruit mass increased by 45%.

### The Role of Intensity in Frequency Combinations

The best general results were obtained by the low energy blue spectrum, as shown in FIG. 36. Recent research has shown that a combination of 662 and 452 nm lights with a combined intensity of 240 μmol/m²/s produced significantly better growth results in tomatoes, and that those results are largely in agreement where combinations of 665 and 455 nm light are close to the same 240 μmol/m²/s combined intensity.

Their results were based upon intensity combinations ranging from 60 to 330 μmol/m²/s. In their research the red frequency light was significantly stronger than the blue light.

| | Light intensity | The wavelengths of red light |
|---|---|---|
| Treatment | (μmolm⁻²s⁻⁸) | and blue light (nm) |
| S1 | 60 | 662 + 452 |
| S2 | 150 | 662 + 452 |
| S3 | 240 | 662 + 452 |
| S4 | 330 | 662 + 452 |
| S5 | Sun light | Full spectrum |

However, the exemplary light sources can include 455 and 590 nm narrow-band light sources with results that match and are supported by the following. Tomato seedlings were subjected to four different light treatments for 60 days: narrow amber light (595 nm), narrow blue+narrow amber light (430 nm+595 nm) with a 1:10 ratio, white LED (455 nm+595 nm), and a high-pressure sodium (HPS) lamp (control). The highest mean fresh mass yield occurred with the narrow blue+narrow amber light (479 g), followed by white LED at 20% less, HPS at 34% less, and narrow amber at 40% less. Dry mass and plant height were similar among light treatments. Supplementing narrow amber light with 430-nm blue light led to a 20% increase in chlorophyll content. Findings indicate that narrow amber light is more efficient in biomass accumulation than broad amber light and that precise selection of different blue and amber wavelengths can greatly impact the growth and development of tomato seedlings. This energy-efficient narrow-wavelength combination shows improvement over white LED lighting for maximizing tomato growth.

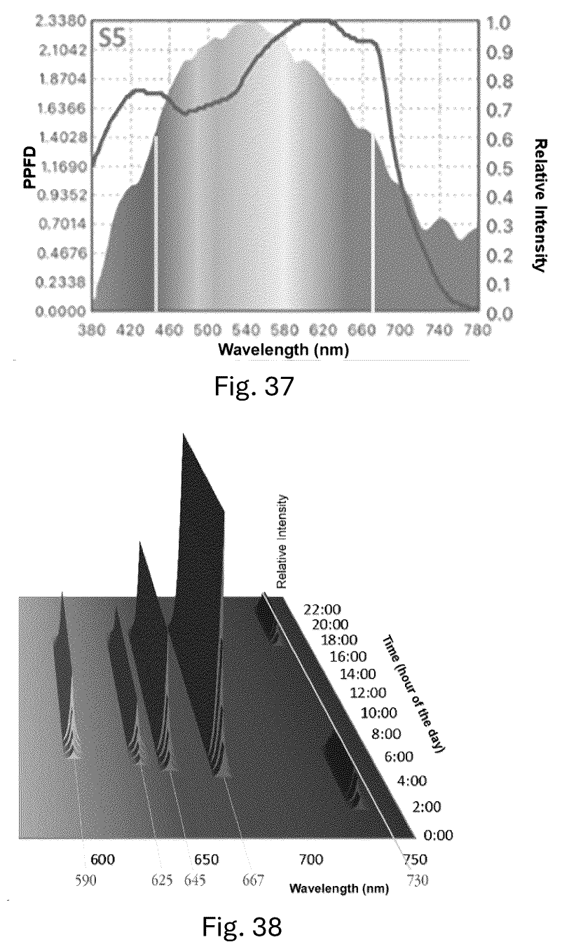

The reason this is interesting is that the combined exemplary light red and blue light sources were nearly equal in intensity while the first research had the red source 40+% stronger in intensity. While it is a common belief in horticulture that red light predominate in intensity, the first research notes that the two narrow bands are shown to occur in sunlight at the same general intensity, as shown in FIG. 37.

The second research shows that the blue (430 nm) color is the key to the growth behavior.

### Adventitious Roots

During the tests, roots appeared on flower stems of the tomato plants in the 100% Red grow-tray. In plants, roots that form from non-root tissues are known as adventitious roots. This general definition distinguishes adventitious roots from primary and lateral roots. However, there are subgroups of adventitious roots that can be formed as a stress response and during normal development or as a response to stress.

The main difference for adventitious creation in some eudicots (e.g. tomato) is the requirement for de novo adventitious root initiation via auxin and ethylene signaling. In the cross section, epidermis and exodermis are combined, but the exodermis can be several cell layers adjacent to the epidermis.

Auxin is a phototropic hormone that promotes cell growth and elongation of the plant. Auxin also influences rooting formations.

During evolution, plants have developed accurate mechanisms to integrate internal signal such as hormones and environmental cues like light and temperature, in order to respond as quickly and efficiently as possible to any change. Several growth and developmental processes, such as seed germination, stem elongation, seedling de-etiolation, cotyledon opening, flower induction and circadian rhythms are activated and/or regulated by both light and hormones, suggesting interactions between signaling pathways.

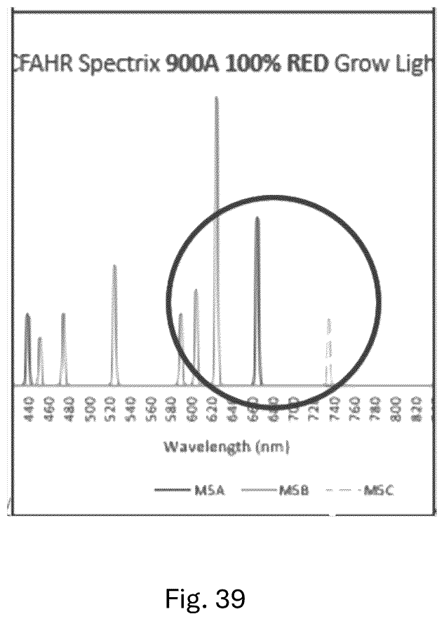

As shown in FIGS. 38 and 39, the absence of a working CRY1a protein makes “the tomato system” more sensitive to changes of phyto-hormone concentration in the growing medium and Adventitious root induction is promoted by high auxin and low cytokinin levels Auxin level are strongly influenced by Phytochrome light signals. Very low ratio Pr/Pfr (665 nm/730 nm) cause such auxin responses and the 100% red spectra has a very low rations compared to typical spectra.

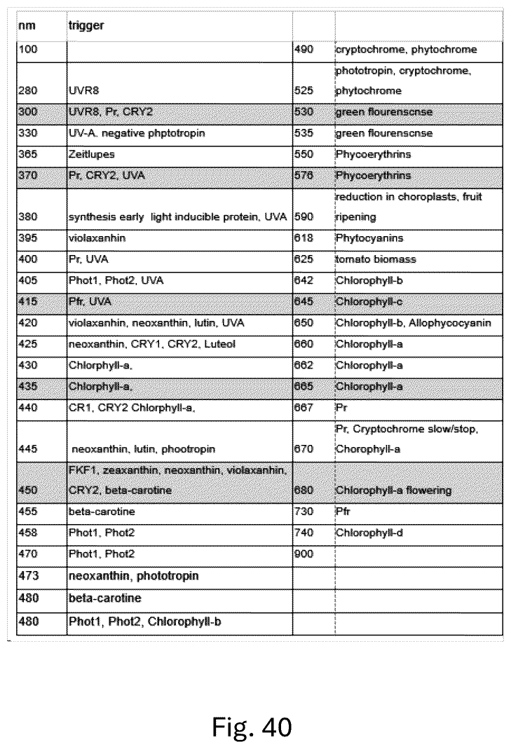

FIG. 40 is a table of narrowband light triggers, including the center wavelength and the response associated with each particular narrowband wavelength of light. The table can be used to create “recipes” of light in order to cause certain desired actions in particular plants.

The presently disclosed subject matter includes methodology that involves using light to signal photoreceptor response that causes signal metabolic components to (metabolites) to be produced that change the equilibrium in the plant, resulting in the plant responding metabolically and altering its growth state. When a response is triggered, the ratio between grow and no-grow moves off of equilibrium. For example, when Chlorophyl 670 grows faster than ratio Pf/PFr phytochrome.

When two or more signal frequencies are stimulated by light frequencies, they produce metabolic signal compounds which cause desired plant/metabolic behavior.

The literature on gene expression and plant metabolic pathway functions is not easily accessed by those outside the specialty. But a basic explanation of key ideas can lead to a functional understanding of how plants react metabolically to environmental information transferred by the plant's interaction with light that hits the plant's photosynthetic and photosensory systems.

This functional explanation is keyed to the document “Narrow Bandwidth Photosensory Spectrum Control Of Plant Metabolic Processes Research” revision 6.3. This document, while based upon and in agreement with rigorous scientific documentation, is not designed to be a scientifically rigorous document but rather a route to understanding and answering a number of fundamental questions about the control and optimization of plant growth systems using Symbiotic Systems patented Spectrix® Metabolic Crop Management intellectual property.

A metabolic process is a chemical reaction or pathway that transforms chemical substances in living organisms. They are part of building molecules or breaking them down. Metabolic processes can involve small molecules or macromolecular processes like DNA repair and replication, and protein synthesis and degradation.

### Plants Can't Move

It is believed that because plants can't move they have developed an extensive capability to dynamically adapt their growth responses to the environment they find themselves in. These responses include the ability to modify their growth instructions in real time. If you will, they can reprogram their growth instructions to adapt to change. However, those adaptations also form interactive stresses on all their associated metabolic processes.

### The Difference Between Photosynthesis and Photosensory Metabolic Processes

Light energy is absorbed by photosensitive chemicals called pigments that have specific levels of absorption per frequency of light they encounter.

Photosynthesis is the metabolic process of pigments capturing energy from photons of specific frequencies and converting it into chemical energy in the form of altered electron valences. This energy transfer drives all plant life processes. Photosynthesis has a system that allows photons from a broad spectrum of initial frequencies to be repeatedly absorbed and remitted at ever lower frequencies until the photon frequency causes its energy to be absorbed into the energy of an electron and made available for plant growth. The primary photosynthetic pigments are Chlorophylls and beta-Carotene.

Photosensory metabolic systems use photosensitive proteins called chromophores to absorb photonic energy of specific frequencies causing specific chemical reactions within the proteins they are embedded with (there are some exceptions). The specific chemical reactions either directly or indirectly cause other chemical reactions. Indirect chromophore initiation of chemical reactions is caused by the initiation of a series of subsequent sub-reactions called signaling pathways.

Signaling pathways typically react with some metabolic pathway (a sequence of chemical reactions that perform some function in plant growth). When signaling pathways interact with metabolic pathways, information is passed from the signal to the metabolic pathway.

The signal information causes:
a. initiation of metabolic pathway activity. For example, the initiation of a gene expression metabolic process.
b. increases or decreases in metabolic pathway activities,
c. changes in the metabolic pathway's chemical sequence after the point of signal interaction in the sequence.

### The Metabolic Factory and the Lower Limit

The metaphor of a Metabolic Factory is a factory where signals from photoreceptors cause specific metabolic components to be manufactured. The factory has gene expression machines building primary metabolic system components. Those gene expressions can be altered by the presence of secondary metabolic system components that act like machine tools allowing different modifications depending on which is present.

But the Metabolic Factory has a built-in limitation under continuous spectra illumination. To control the metabolic factory, the signals need to be discrete. Each signal frequency needs to invoke a specific plant response.

The limitation is that the factory produces metabolic components as a function of the amount of energy received by photosensory signal receptors that directly cause signal response or create signal pathways. Since the absorption spectra of photosensory receptor pigments cover a broad frequency bandwidth, illuminators with a continuous spectrum don't trigger single specific metabolic (discrete) responses but one or more groups of metabolic responses. The signal that prevails in the plant is the one with the greatest concentration of signal caused metabolites in solution.

Consider Phytochrome signals. There are two phytochrome signal states, Pr and Pfr, that negate each other's metabolic plant response. Each state has an absorption spectrum that represents the lighting conditions (illuminator frequencies and intensities) that cause the greatest and the least of its signal created metabolite to be present in the plant.

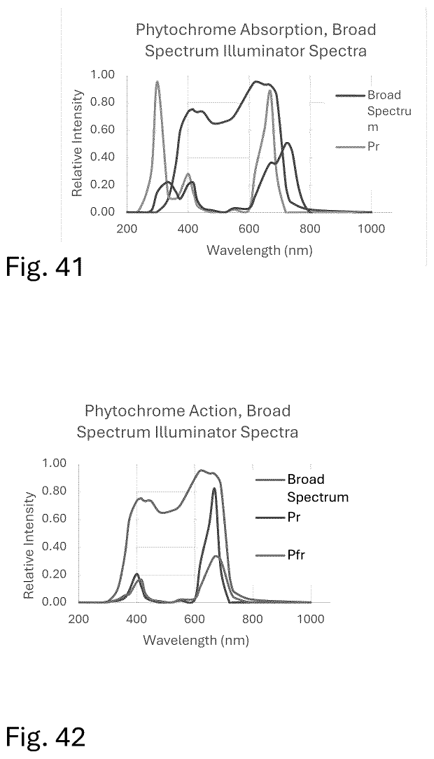

FIG. 41 is a graph that shows the absorption spectrums of the two Phytochrome signal metabolites and the illumination spectrum of a commercially available broad-band illuminator. The Phytochrome metabolite concentration that results, given that all other conditions are constant, is proportional to the amount of energy offered in the illuminator spectrum reduced by the each Phytochrome state's absorption spectrum sensitivity at each frequency.

The resulting action spectrum for each Phytochrome state, shown in FIG. 42, measures how much of the illuminator's spectrum of energy is being absorbed (the absorption efficiency of the illuminator's energy) as transmitted to the metabolic factory. The calculation of the total amount of signal energy received by the phytochromes is the area under the action spectrum curve. It is clear before metabolic control can be achieved the action spectrum cross sectional-area overlap has to be minimized, for each signal to be controlled, until their effects relative to each other are negated or minimized as much as possible.

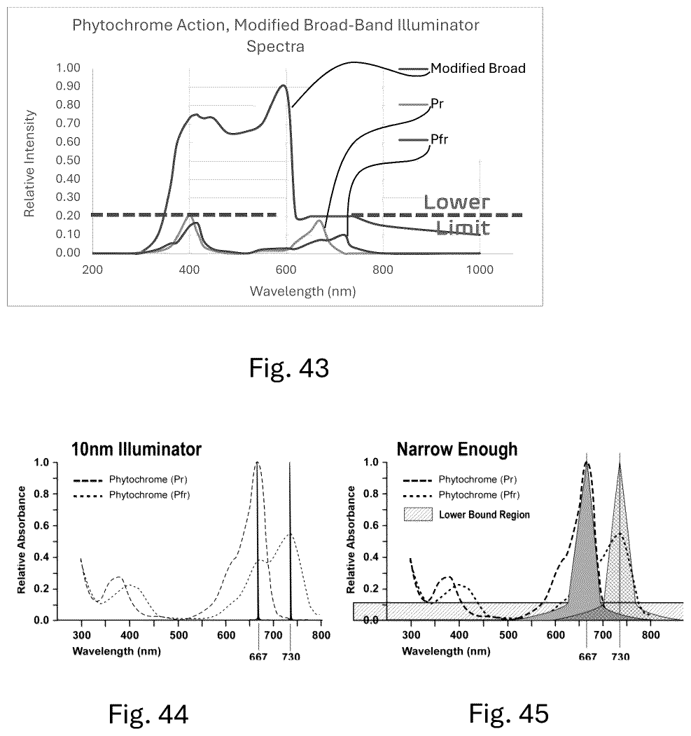

FIG. 43 is a graph that shows a broad-band continuous spectrum illuminator that has been modified to cause the phytochrome action spectra to give each signal state equal energy (equal areas under the action spectra curves). In this case this occurs at about 20% relative illuminator or the intensity level where the two signal states are equal or lack a selection is called the lower limit.

### The Lower Limit and the Gene Expression Machine

The metaphor for how the primary and secondary metabolic systems interact is the Gene Expression Machine.

Within each Metabolic Factory are one or more associated Primary Metabolic System Gene Expression machines, and one or more machine tools (Secondary Metabolic System metabolite interactions) per machine that allow the gene expression or its metabolic process to be modified in some way according to real-time signals from the plant or its environment.

For each photoresponse there are one or a plurality of frequencies that cause the photoreceptor to cause signaling pathways that invoke or modify gene expression or other metabolic responses. Many of the signal pathways form controls that increase or decrease a specific metabolic response. Some work as switches causing or ending a response or changing it from one response state to another.

The lower limit is the illuminator intensity level where one or more frequency intervals invoking or signaling metabolic pathway response are either not triggered or don't cause metabolic states to be reversed or altered.

All the lower limits for a group of controls form a spectrum that is the basis for metabolic crop control because at all the desired control frequencies, it has an intensity level such that the controlled metabolic response signal is or signals are off-setting, minimum, or disappearing. This means that to cause a control event supplemental lighting sources more intense than the lower limit must be added, changed in intensity, or turned off.

For example, The phytochrome regulation of plant growth speed involves two photochrome states, Pr (slower) and Pfr (faster). The proteins can be reversibly switched between the states with red light (Pr→Pfr) and far-red light (Pfr→Pr).15

### Photosensory Control Signals

When one to a plurality of illuminators with photoreceptor frequencies irradiate a photoreceptor to an intensity that cause the photoreceptor to create a signaling pathway strong enough to cause a desired metabolic response, and that irradiation has a bandwidth narrow enough that they do not simultaneously cause other unwanted signaling pathways to be created, a control pattern has been created such that the presence of the control pattern illumination results in the signaling pathway and the lack of it causes the desired metabolic response to be diminished or disappear. This intensity level where signal crosstalk is minimal or nonexistent is called the lower limit.

### Narrow-Band

There are two types of narrow-band lower limit concepts. The 10 nm Illuminator portrays idealized narrowband illumination with zero light intensity as the lower bound. The Narrow Enough graphic has illuminators whose cross-sectional bandwidth is separate at the lower bound and remain so to the maximum intensity. In the Narrow Enough case, the overlap of the illuminators

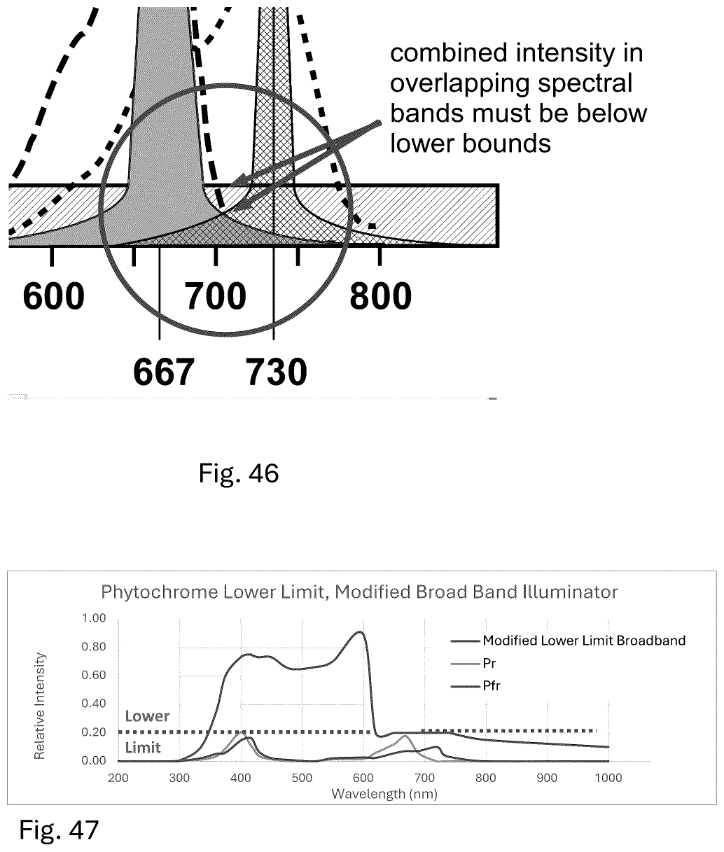

FIG. 44 depicts a 10 nm graphic and portrays idealized narrowband illumination with zero light intensity as the lower bound. FIG. 45 depicts a “Narrow Enough” graphic that has illuminators whose bandwidths are separate at the lower bound and the sum of their overlapping cross-sectional energy is less than the lower limit. FIG. 46 is a close-up view of a portion of the graph of FIG. 45.

### Broadband Spectrum

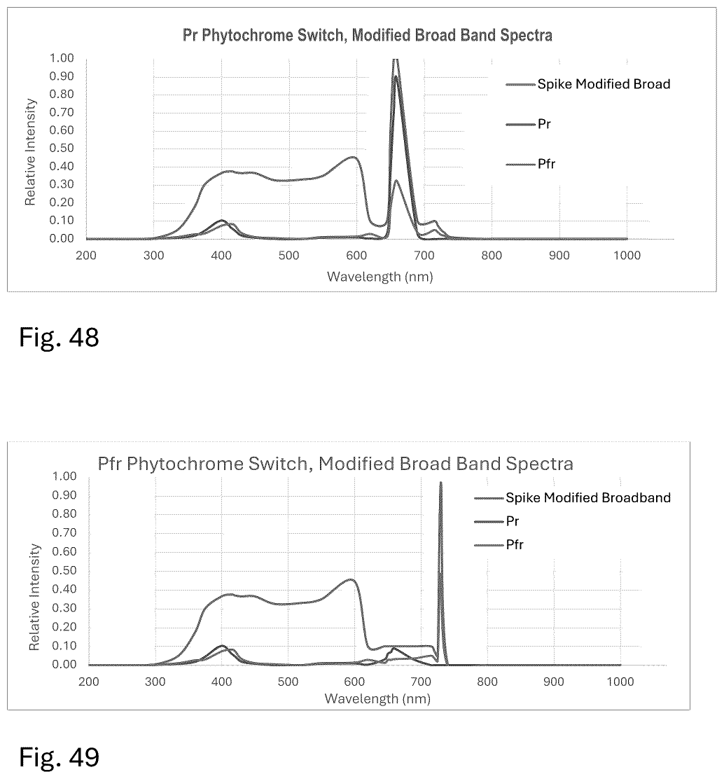

As shown in FIGS. 47-49, road-band continuous spectrum illumination may have a lower limit that is itself a broad band continuous spectrum. Returning to the Phytochrome example, the Phytochrome lower limit spectrum is reduced to 20% relative intensity above 610 nm. By adding supplemental narrow-band light sources at 657 nm and 730 nm the following action spectra results in a phytochrome switch.

### A Multi-Channel Metabolic Control Example

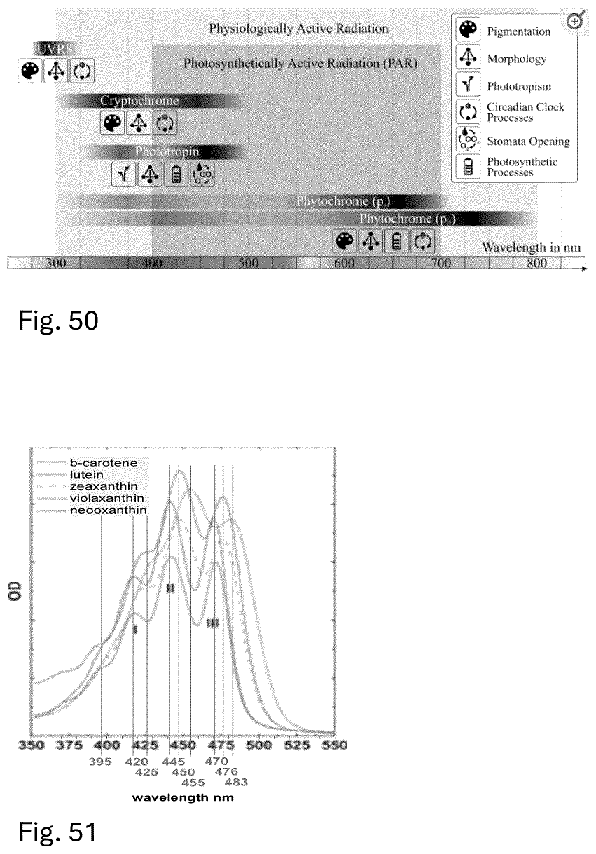

The Phytochrome example is a simple lower limit model. Photosensory metabolic signals involve at least 28 signal frequencies spread over spectrum. The distribution of some types is shown in FIG. 50.

The peaks within some of these spectral ranges are often very close together. This necessitates very narrow bandwidth illuminators. The carotenoids shown in FIG. 51 are used in both photosensory and photosynthetic processes. Their absorption spectra require that illuminators have a bandwidth of 5 nm (+/−2.5 nm around a center frequency) or less if the lower limit rules are to be followed.

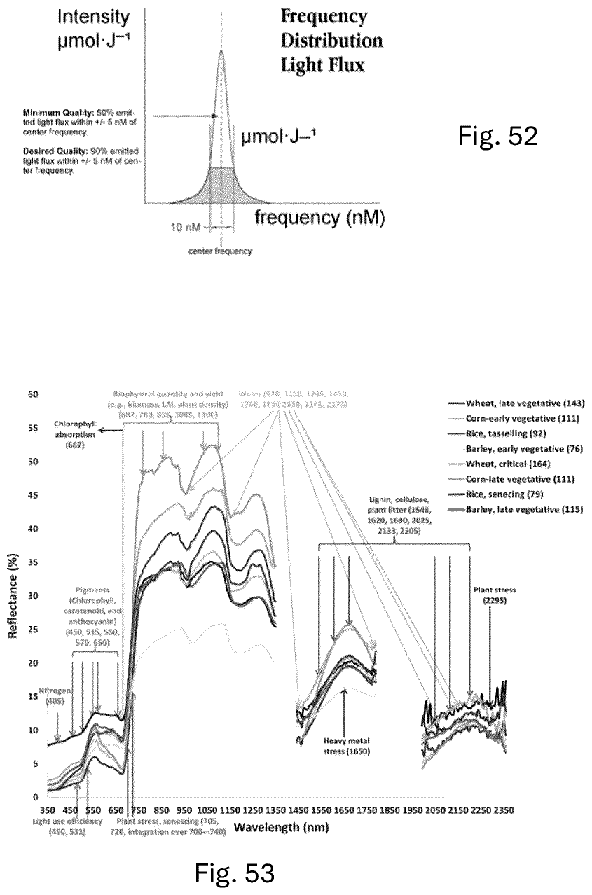

The intensity of light incident on the surface of the plant is measured by PPFD (Photosynthetic Photon Flux Density). It measures the number of photons with frequencies in the photosynthetically active radiation (PSAR) spectrum that fall within a square meter in one second. The PPFD measurement unit is micromoles per square meter per second (μMol/m²/S). Symbiotic Systems uses a broader photon frequency spread. We chose photosensory active radiation (PSAR) from 200 nm to 2500 nm. Our maximum device target intensity at a distance of 100 cm from the light source is between 1500 and 2000 PPFD. To achieve narrow bandwidths, we reduce the LED driver energy to 1000 to 1500 PPFD at 100 cm from the light source. FIG. 52 shows such a frequency distribution light flux.

The lights also measure the reflectance spectrum of leaves. This includes wavelengths in the far-infrared. The graph of FIG. 53 shows these general classes.

### The Gene Expression Machine

The metaphor for how the primary and secondary metabolic systems interact can be considered an example of the Gene Expression Machine.

Within each Metabolic Factory are one or more associated Primary Metabolic System Gene Expression machines, and one or more machine tools that allow the gene expression or its metabolic process to be modified in some way according to real-time signals from the plant or its environment.

The fundamental concept is that the environmental signals cause concentrations of metabolites to exist that drive reaction structures based upon equilibriums. If there is a metabolite that has several forms depending upon the frequency of photonic energy that signaled its creation, or two different metabolites that reduce each other based upon concentrations, then the plant's behavioral reaction will be based upon the changes in the ratio of the metabolites in solution. This ratio is constantly changing as the concentrations change seeking equilibrium and are reset according to the strength of the signals replenishing the metabolite presence in each form.

This idea is especially important to understand. Where creation of new metabolites levels caused by signal energy perturbs the chemical equilibrium present, it initiates chemical responses correlated with the restoration of chemical equilibrium that unless maintained by future signals will automatically cause change unless in rest state.

### Photosensory Control Signals

Each photosensor has a pigment that has an absorption spectrum of its specific ability to absorb photons of each specific frequency.

As shown in FIG. 24, the absorption spectrum for a photoreceptor of the Phytochrome family changes depending on the molecular shape it has. It has two different molecular shapes called Pr and Pfr and their absorption spectra reflect the differences in molecular shape. Pr is most sensitive to photons at 670 nm and not at all at 730 nm. Pfr is sensitive to photons of 730 nm and a lesser amount at 670 nm.

The absorption spectrum of the Phytochrome interacts with the spectrum of the illuminator as a filter where the actual energy received at a given frequency is the amount offered at that frequency reduced by the sensitivity of the pigment at that frequency.

Red intensities cause Pr Phytochrome to change state to Pfr and some Pfr to revert to Pr. The two absorption spectra overlap and have a ratio of their cross-sectional areas where given signal frequencies cause both Pr->Pfr and Pfr->Pr reactions. The table is an analytical listing of these cross-sectional area ratios per 10 nm wide slice.

The cross-sectional area ratio of Pr to Pfr in a plant illuminated by a continuous spectrum is determined by the ratio of the areas under the two active absorption spectra of the photosensory pigments.

FIG. 41 shows absorption spectra of Pr and Pfr plotted with the illumination spectra of a commercially available broad-spectrum illuminator. The interaction between the illumination source spectra and the absorption spectra of the Phytochrome looks like this in the graph of FIG. 42.

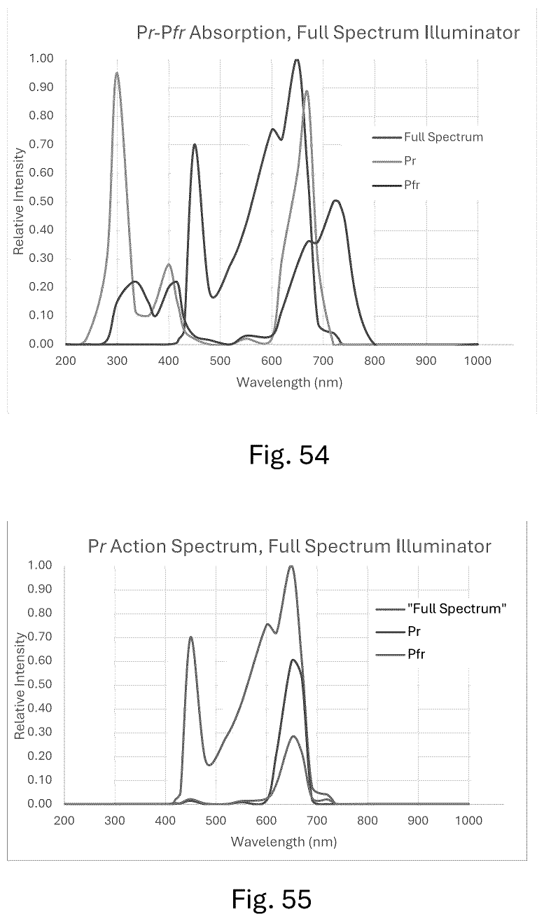

Since the metabolic signal intensity is the area under the curve in each case, and since Pr signals inhibit or slow down the speed of plant biomass growth it and Pfr signals increase the speed of biomass growth, it may be desirable to increase the Pfr signal strength to increase the biomass produced in a given grow period. For example: a typical effort to achieve higher growth rates is to use an illuminator with an optimized spectra by adding significantly higher illumination levels in spikes around certain frequencies. The graph of FIG. 54 shows such the absorption spectra of Pr and Pfr and the illumination spectra by frequency from a commercially available full spectrum illuminator with an optimized continuous spectrum.

And again, the interaction between the illumination source and the absorption spectra of the Phytochrome looks like the graph shown in FIG. 55.

Even with the strong relative emphasis of the red frequencies, the overall change is less than might be expected because the continuous spectrum illuminator, even when intensely spiked in the red, has difficulty significantly altering the ratio of metabolic signal types because you can't choose only the frequencies that produce optimum signal levels and the result is that the cross-sectional area under the action spectra remains similar even with major spectral change.

To build a plant growth control system that allowed the grower to interactively control biomass development speed, then you need to be able to change the spectrum dynamically and each state signal has to be able to change the Phytochrome state cross-sectional area ratio dramatically more than is possible with any form of continuous spectrum lighting including those with strong supplemental narrow band sources. If an illuminator used with three narrow band sources at 300 nm 650 nm and 730 nm, a Phytochrome switch is created.

The resulting action spectrum shown in FIG. 24 has the highest possible ratios between Pr and Pfr in both in the red and the far-red. By turning on the 730 nm to slow biomass growth or selecting 300/650 nm to speed up biomass growth the control I established. By varying the intensity of 300 nm relative to 650 nm light and 730 nm respectively to both a continuous range of signal strengths can be achieved.

### The Basil Metabolic Control Example

The GLAB Tests done with Basil plants demonstrated this switch effect. The illuminator had ten nm wide narrow-band light sources shown in FIG. 31′B. It also had dynamic time-control of frequency intensity.

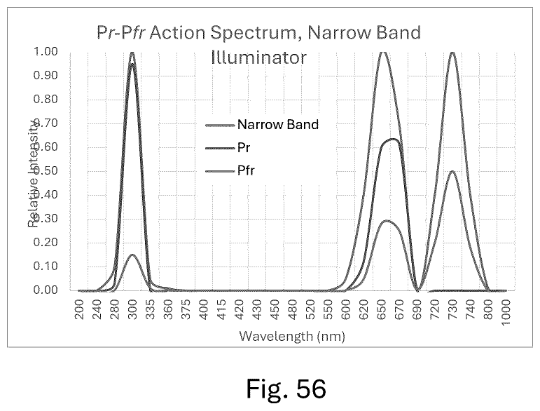

Each of the LED types could be independent set on or off and to any intensity between maximum power consumption and zero. The schedule of light intensity is shown in FIGS. 20 and 56.

By varying the intensity of each color as a function of time the basil plant was driven to change the equilibrium dynamics controlling its growth rate. The result was a demonstration that the Phytochrome ratios between Pr and Pfr had indeed been increased significantly over continuous spectrum light sources and produced 200% increases in biomass growth at half the watts per gram produced.

There is another deeply important issue. The cost of using illuminators is not likely to decrease. As the move to electrification continues, the cost of electrical power will increase not decrease unless a significant move to nuclear power is accepted. Using non-continuous spectrum light sources reduces grow energy costs significantly while multiplying the product output. The basil tests reveal a 200% increase in biomass per watt energy expenditure.

The grow results are not a reflection of LEDs vs High Pressure Sodium light sources, but rather a reflection of change in spectral structure of the light offered and the ability to use the Phytochrome switch and its direct effect on plant growth dynamics. It is also clear continuous spectrum LED light sources are incapable of invoking anything but the same high cross section ratios.

While certain embodiments of the invention are described above, it should be understood that the invention can be embodied and configured in many different ways without departing from the spirit and scope of the invention.

Embodiments are disclosed above in the context of light emitting diodes but the disclosure contemplates the use of other types of lighting including lasers, laser diodes, plasma lamps, incandescent lamps, and other narrowband light sources.

The term Spectrix is used to describe an LED (or light cob using LEDs) made in accordance with principles of the presently disclosed subject matter.

Exemplary embodiments are intended to cover all software or computer programs capable of enabling processors to implement the above operations, and designs. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above. The computer can be a personal computer, a server, a series of servers, cloud based networks, firmware, (ASIC), or other known device or computing system.

What is claimed is:

1. A method for growing a plant, comprising:
providing a plant that has a known light control pattern for photosensory photoreceptors;
providing lights having wavelength characteristics that match the light control pattern for photosensory photoreceptors of the plant where such control pattern is selected to be an optimum cause of desired control behavior;
changing at least one of an intensity, a duration, and a periodicity of the lights to achieve a desired metabolic response in the plant;
preventing light outside of the light control pattern, with an intensity that is above a lower bound required for the photoreceptors of the plant to be controlled, from making contact with the plant.

2. The method of claim 1, wherein providing lights includes providing at least one first light source that has a center frequency and bandwidth consistent with inclusion in the control pattern, and a second light source that has a center frequency and bandwidth consistent with inclusion in the control pattern, the second light source having a center frequency different from the center frequency of the first light source, wherein
the first light source is a narrowband light emitting diode having a wavelength range of 10 nanometers or less, and the second light source is a narrowband light emitting diode having a wavelength range of 10 nanometers or less.

3. The method of claim 1, wherein the lower bound is zero such that only light matching the control pattern is provided to the plant, and such that a continuous illuminating spectrum is not provided to the plant.

4. The method of claim 1, wherein preventing light includes placing the plant and lights into a confined space in which ambient light is substantially restricted from entry into the confined space.

5. The method of claim 1, wherein changing at least one of an intensity, a duration, and a periodicity of the lights causes a signal pathway to exist such that the lights influence at least one of a primary and a secondary metabolic process in the plant.

6. The method of claim 1, wherein changing at least one of an intensity, a duration, and a periodicity of the lights causes a desired gene expression in the plant.

7. The method of claim 1, wherein the lights include a plurality of narrowband light sources that each have a bandwidth such that the intensities of the light from any combination of overlapping narrowband light sources added together, within their regions of spectral overlap, have a combined intensity that is below the lower bound, the lower bound defined by an intensity required for the photoreceptors of the plant to change the desired metabolic response of the plant to be controlled or cause an undesired response or initiate an undesired process or change any other process not directly part of the desired metabolic response, and the method further includes; operating the narrowband light sources in a first combination of frequency and intensity to invoke a desired signaling pathway in the plant but not in a second combination that invokes undesired signal pathways.

8. The method of claim 1, wherein providing a plant includes providing a plant that has a known light control pattern for photosensory photoreceptors; and
providing lights includes providing lights having wavelength characteristics that match the light control pattern for both photosynthesis and photosensory photoreceptors of the plant, and
preventing light outside of the light control pattern from making contact with the plant includes preventing light with an intensity that is above the lower bound from making contact with the plant, the lower bound being an intensity required for the photoreceptors of the plant to change the desired metabolic response or initiate an undesired process or change any other process not directly part of the desired metabolic response.

9. The method of claim 1, further comprising:
providing a controller that includes a memory in which a plurality of light pattern recipes are stored, each of the recipes corresponding to a different desired metabolic response for the plant; and
operating the lights in accordance with one of the plurality of light pattern recipes such a that a plurality of discrete narrowband wavelength lights are incident upon the plant.

10. A method for growing a plant, comprising:
providing a plurality of narrowband light emitting devices that each, during operation, emits light in a specific wavelength range that corresponds to a specific wavelength range that causes a predetermined process in the plant, each specific wavelength range having a range of 20 nanometers or less;
placing the plurality of narrowband light emitting devices into a space;
preventing ambient light from entering into the space;
operating the plurality of narrowband light emitting devices to cause only light within each specific wavelength range to be incident upon the plant.

11. The method for growing a plant according to claim 10, wherein the specific wavelength range is a wavelength range of 10 nanometers or less.

12. The method for growing a plant according to claim 10, wherein the plurality of narrowband light emitting devices includes a first narrowband light emitting device having a first wavelength range, a second narrowband light emitting device having a second wavelength range different from the first wavelength range, and third narrowband light emitting device having a third wavelength range different from the first wavelength range and the second wavelength range, and each wavelength range is 10 nanometers or less and does not overlap with other wavelength ranges.

13. The method for growing a plant according to claim 12, wherein the plant is a tomato and the first wavelength range, second wavelength range, and third wavelength range are each selected from the group consisting of: 365+/−5 nm; 384+/−5 nm; 415+/−5 nm; 435+/−5 nm; 455+/−5 nm; 472+/−5 nm; 525+/−5 nm; 590+/−5 nm; 622+/−5 nm; 640+/−5 nm; 650+/−5 nm; 667+/−5 nm; and, 730+/−5 nm.

14. The method for growing a plant according to claim 10, wherein the plurality of narrowband light emitting devices includes light emitting diodes that each emit light within a 10 nanometer bandwidth.

15. The method for growing a plant according to claim 10, wherein
the plurality of narrowband light emitting devices each, during operation, emits light in a specific wavelength range that in combination creates a first wavelength pattern that causes a predetermined process in the plant, each specific wavelength range having a bandwidth range such that intensities of the light from any combination of overlapping narrowband light sources added together, within their regions of spectral overlap, have a combined intensity that is below a lower bound required for photoreceptors of the plant to change a desired metabolic response of the plant to be controlled or cause an undesired response or initiate an undesired process or change any other process not directly part of the predetermined process;
preventing ambient light includes preventing ambient light from entering into the space in an intensity greater than the intensity of the lower bound required for the photoreceptors of the plant to change the desired metabolic response of the plant to be controlled or cause an undesired response or initiate an undesired process or change any other process not directly part of the predetermined process;
operating the plurality of narrowband light emitting devices includes operating the plurality of narrowband light emitting devices to cause only light within each specific wavelength range to be incident upon the plant in intensities above the lower bound required for the photoreceptors of the plant to change the desired metabolic response of the plant to be controlled.

16. The method for growing a plant according to claim 10, wherein the plurality of narrowband light emitting devices includes at least one first narrowband light emitting device having a first wavelength pattern, at least one second narrowband light emitting device having a second wavelength pattern different from the first wavelength pattern, and at least one third narrowband light emitting device having a third wavelength pattern different from the first wavelength pattern and second wavelength pattern such that intensities of the light from any combination of overlapping narrowband light sources within a wavelength pattern added together, within regions of spectral overlap, have a combined intensity that is below a lower bound required for photoreceptors of the plant to change a desired metabolic response of the plant to be controlled or cause an undesired response or initiate an undesired process or change any other process not directly part of the predetermined process; and
preventing ambient light includes preventing light from entering into the space in an intensity greater than the intensity of the lower bound required for the photoreceptors of the plant to change the desired metabolic response of the plant to be controlled or cause an undesired response or initiate an undesired process or change any other process not directly part of the predetermined process.

17. The method for growing a plant according to claim 10, wherein operating includes operating the plurality of narrowband light emitting devices in combination or in time series.

18. A method for controlling a plant, comprising:
providing a plurality of narrowband light emitting devices that each, during operation, emits light in a specific wavelength range that corresponds to a specific wavelength range that causes a predetermined process in the plant, each specific wavelength range having a range such that intensities of the light from any combination of overlapping narrowband light sources added together, within their regions of spectral overlap, have a combined intensity that is below a lower bound required for the photoreceptors of the plant to change a desired metabolic response of the plant to be controlled or cause an undesired response or initiate an undesired process or change any other process not directly part of the predetermined process;
placing the plurality of narrowband light emitting devices into a space;
preventing ambient light from entering into the space; and
operating the plurality of narrowband light emitting devices to cause a first pattern of light to be incident upon the plant, wherein the first pattern of light includes a plurality of lights each centered on a particular wavelength and having a narrowband wavelength range of 10 nanometers.

19. The method for controlling a plant according to claim 18, further comprising:
preventing ambient light from entering into the space in intensities above the lower bound required for the photoreceptors of the plant to change the desired metabolic response or initiate an undesired process or change any other process not directly part of the desired process, from making contact with the plant.

20. The method for controlling a plant according to claim 18, further comprising:
providing a controller connected to the light emitting devices, the controller configured to cause a first pattern of light to be emitted from the light emitting devices to initiate the predetermined process in the plant upon which the first pattern of light is incident, wherein the first pattern of light includes a plurality of lights each centered on a particular wavelength and having a narrowband wavelength range such that intensities of the light from any combination of overlapping narrowband light sources added together, within their regions of spectral overlap, have a combined intensity that is below a lower bound required for photoreceptors of the plant to change the predetermined process from occurring in the plant or cause an undesired response or initiate an undesired process or change any other process not directly part of the predetermined process;
providing at least one spectral imaging sensor connected to the controller and configured to provide feedback information to the controller to confirm whether the predetermined process is occurring, wherein
the controller includes a memory in which a plurality of light pattern recipes are stored, each of the recipes corresponding to a different predetermined process for the plant.
